(19) United States
(12) Patent Application Publication
(10) Pub. No.: US 2025/0061719 A1
(43) Pub. Date: Feb. 20, 2025

(54) System and Method for Work Zone Management

(71) Applicant: NEW YORK UNIVERSITY, New York, NY (US)

(72) Inventors: Jingqin Gao, Brooklyn, NY (US); Fan Zuo, Brooklyn, NY (US); Kaan Ozbay, Princeton, NJ (US); Chuan Xu, Brooklyn, NY (US); Liu Yang, Brooklyn, NY (US); Daniel Zhang, Niskayuna, NY (US)

(21) Appl. No.: 18/804,316

(22) Filed: Aug. 14, 2024

Related U.S. Application Data
(60) Provisional application No. 63/519,368, filed on Aug. 14, 2023.

(51) Int. Cl. G06V 20/50; G06N 20/00; G06Q 10/063

(52) U.S. Cl. CPC G06V 20/50; G06N 20/00; G06Q 10/063

(57) ABSTRACT

Aspects of the present invention relate to a method for work zone management, including the steps of providing one or more images of a work zone, analyzing the one or more images to detect one or more work-zone related objects within the work zone, sizing the detected work-zone related objects by comparing the detected objects to known sizes of common work zone equipment to establish a scale, calculating estimated positions of the one or more work-zone related objects, mapping the one or more work-zone related objects to a topological map, calculating a topology complexity score based on the topological map, and determining whether the work zone is an organized work zone or a random accumulation of work zone objects, based on the topology complexity score.

### CROSS-REFERENCE TO RELATED APPLICATIONS

This application claims priority to U.S. Provisional Application No. 63/519,368 filed on Aug. 14, 2023, incorporated herein by reference in its entirety.

### STATEMENT REGARDING FEDERALLY SPONSORED RESEARCH OR DEVELOPMENT

This invention was made with government support under 69A3351747124 awarded by the U.S. Department of Transportation. The government has certain rights in the invention.

### BACKGROUND OF THE INVENTION

Work zones, temporary areas established along roadways for maintenance, construction, or other activities, play a pivotal role in urban infrastructure development. However, the presence of work zones within highway networks and urban roadways often leads to traffic interruptions, capacity reductions, congestion, and safety concerns. Managing work zones effectively is essential to mitigate these adverse impacts and maintain efficient traffic flow.

The occurrence of work zone activities within highway networks and urban roadways can induce substantial traffic interruptions. These operational disruptions often result in roadway capacity reduction (i.e., by closing down one or more lanes) that might lead to severe congestion and roadway crashes. On the one hand, work zones have contributed to approximately ten percent of highway congestion in the U.S., resulting in an estimated annual loss of $700 million in fuel alone [P. K. Edara, C. Sun, A. Robertson et al., “Effectiveness of work zone intelligent transportation systems,” Iowa State University. Institute for Transportation, Tech. Rep., 2013], while exacerbating the negative environmental effects of vehicle emissions and increasing safety risks [P. Edara, R. Rahmani, H. Brown, C. Sun et al., “Traffic impact assessment of moving work zone operations,” Smart Work Zone Deployment Initiative, Tech. Rep., 2017]. For example, one study found that the crash rate increased by 24.4% under work zone conditions compared to non-work zone conditions [O. Ozturk, K. Ozbay, and H. Yang, “Estimating the impact of work zones on highway safety,” Tech. Rep., 2014]. On the other hand, while offline data sources such as work zone permit data may be available, the majority of U.S. cities have yet to establish a real-time approach to monitor actual activities during operational periods of work zones throughout the road network.

Given these concerns, real-time work zone detection becomes crucial. Knowing the location, duration, size of the work zones in real-time can provide vital insights into their impact on traffic flow and safety and help decision makers strategically allocate resources through the Transportation Management System (TMS).

One viable approach to detecting work zones in real-time is using computer-vision-based detection by means of images acquired from existing traffic cameras. While these traffic cameras are extensively used for pedestrian and vehicle detection, their application to road work zone detection, especially in complex urban settings, remains limited. Urban work zones are uniquely challenging due to pedestrian and vehicular activities, complex surroundings, and lack of standardized setups.

The majority of existing studies using computer vision for work zones focus on off-street sites that might employ different types of equipment than those seen in roadside work zones, or they concentrate solely on detecting a single type of work zone component (e.g., traffic cones) [I. Katsamenis et al., “Tracon: A novel dataset for real-time traffic cones detection using deep learning,” in Novel & Intelligent Digital Systems. Springer, 2022, pp. 382-391]. Moreover, the mere recognition of work zone equipment does not necessarily confirm the presence of a work zone, as such equipment can sometimes serve other purposes, including regulating traffic (e.g., using barrels to separate traffic lanes). Consequently, there is a need for a new methodology that identifies work zone scenes in their entirety rather than simply detecting individual pieces of some work zone equipment.

A main challenge for work zone detection using computer vision technologies identified throughout the literature is the scarcity of publicly available, large-scale, domain-specific, annotated datasets of work zone imagery [N. D. Nath and A. H. Behzadan, “Deep convolutional networks for construction object detection under different visual conditions,” Frontiers in Built Environment, vol. 6, p. 97, 2020], [R. Duan et al., “Soda: Site object detection dataset for deep learning in construction,” arXiv preprint arXiv: 2202.09554, 2022], [I. Katsamenis et al., “Tracon: A novel dataset for real-time traffic cones detection using deep learning,” in Novel & Intelligent Digital Systems. Springer, 2022, pp. 382-391]. For example, Nath and Behzadan [N. D. Nath and A. H. Behzadan, “Deep convolutional networks for construction object detection under different visual conditions,” Frontiers in Built Environment, vol. 6, p. 97, 2020] used a convolutional neural network (CNN) model that laid out a framework for detecting the most common types of off-street construction objects, namely, buildings, equipment, and workers. The study recognized a lack of publicly available annotated work zone imagery datasets and introduced a systematic approach to visual data collection through crowd sourcing and web-mining and annotating the collected dataset for AI model training to overcome the limitation. A total of 3,500 images with 11,500 work zone elements were collected and tested both YOLO-v2 and -v3, achieving a best-performing model with a 78.2% Mean Average Precision (mAP).

Duan et al. [R. Duan et al., “Soda: Site object detection dataset for deep learning in construction,” arXiv preprint arXiv: 2202.09554, 2022] also stated that the lack of large-scale, open-source dataset for the construction industry limited the development of computer vision algorithms as they are often data-hungry. This study developed a new large-scale work zone image dataset, Site Object Detection dataset (SODA), with a total of 19,846 images and achieved a maximum mAP of 81.47%. The limitation of this dataset is it is mainly for off-street work zones and may not be suitable for detecting work zones that occur on the roadways.

Another study conducted by Katsamenis et al. [I. Katsamenis et al., “Tracon: A novel dataset for real-time traffic cones detection using deep learning,” in Novel & Intelligent Digital Systems. Springer, 2022, pp. 382-391] used Yolov5 for traffic cone detection using a training dataset of 500 traffic cones images. The data used in this paper was collected and manually annotated under the framework of the H2020 HERON project. The results showed that the proposed computer vision model could achieve a 91% accuracy in detecting traffic cones. However, especially in urban work zones often composed of multiple types of construction objects and having no standard work zone set up, single object type detection may not be as effective as expected.

In recent years, the advancement of deep learning and computer vision techniques has shown promise in automating the detection and management of work zones. The ability to automatically recognize work zones and accurately estimate their sizes in real-time holds the potential to revolutionize transportation management systems. Such technology can provide vital insights into the impact of work zones on traffic, safety, and mobility, enabling prompt decision-making and resource allocation.

However, the deployment of automated work zone management or detection systems in complex urban environments presents unique challenges. Urban work zones are characterized by intricate surroundings, diverse vehicular and pedestrian activities, and a lack of standardized setups. Existing approaches to work zone management or detection often focus on individual work zone components, such as traffic cones or barricades, rather than comprehensively identifying entire work zone scenes. Moreover, the scarcity of large-scale, domain-specific, annotated datasets for work zones poses a significant limitation in training accurate detection models.

Additionally, most of the existing Artificial Intelligence (AI) applications adopt model-centric approaches wherein data collection is perceived as a one-time event to improve the model architecture to enhance its performance [M. Motamedi, N. Sakharnykh, and T. Kaldewey, “A data-centric approach for training deep neural networks with less data,” arXiv preprint arXiv: 2110.03613, 2021]. However, given the inherent scarcity of open-source training samples for work zone detection, the current limitation in this domain is the lack of data rather than shortcomings in the model. This constrains the development of computer vision algorithms for this specific problem, which typically require substantial amounts of data.

Thus, there is a need in the art to develop an efficient and accurate system and method for work zone management that can autonomously identify work zones in complex environments and estimate their sizes in real-time. The present invention meets this need.

### SUMMARY OF THE INVENTION

Aspects of the present invention relate to a method for work zone management including the steps of providing one or more images of a work zone, analyzing the one or more images to detect one or more work-zone related objects within the work zone, sizing the detected work-zone related objects by comparing the detected objects to known sizes of common work zone equipment to establish a scale, calculating estimated positions of the one or more work-zone related objects, mapping the one or more work-zone related objects to a topological map, calculating a topology complexity score based on the topological map, and determining whether the work zone is an organized work zone or a random accumulation of work zone objects, based on the topology complexity score.

In some embodiments, the step of mapping the one or more work-zone related objects to a topological map includes detecting and recording the inter-connectedness of the one or more work-zone related objects within the work zone. In some embodiments, the step of calculating a topology complexity score includes utilizing density-based clustering algorithms to group the detected work zone related objects and calculating the score based on the resulting graph features. In some embodiments, the one or more work-zone related objects are selected from traffic cones, barricades, barrels, chain fences, construction vehicles, signs, or workers.

In some embodiments, the method includes the step of obtaining images of the work zone from traffic cameras, web-mined images, or synthetic work zone images generated by a 3D simulator.

In some embodiments, the method includes the step of estimating the work zone size using the established scale. In some embodiments, the step of estimating the work zone size includes dividing the image of the identified work zone into hyper-planes oriented perpendicularly to the horizontal plane, calculating the real-to-pixel distance ratios for each hyper-plane, and estimating the work zone size based on known sizes of common work zone equipment.

In some embodiments, the method includes the step of training a machine learning model by iteratively augmenting a training dataset with additional images of work zones.

Aspects of the present invention relate to a system for work zone management having a non-transitory computer-readable medium with instructions stored thereon, which when executed by a processor, performs any disclosed methods or steps thereof.

Aspects of the present invention relate to a method for work zone size estimation having the steps of providing a weighted graph of roads in a locality including a plurality of nodes and a plurality of edges connecting the nodes, each node representing an intersection and each edge representing a road, providing one or more images of a work zone in the locality, analyzing the one or more images to detect one or more work-zone related objects within the work zone, calculating estimated positions of the one or more work-zone related objects using known approximate sizes of the work-zone related objects, mapping the one or more work-zone related objects to a topological map, calculating an estimated work zone size based on the topological map, calculating a topology complexity score based on the topological map, adjusting a weight of at least one edge in the weighted graph based on the calculated size and topology complexity score, and providing the updated weighted graph to a database in real time.

In some embodiments, the step of mapping the one or more work-zone related objects to a topological map includes detecting and recording the inter-connectedness of the one or more work-zone related objects within the work zone. In some embodiments, the step of calculating a topology complexity score includes utilizing density-based clustering algorithms to group the detected work zone related objects and calculating the score based on the resulting graph features. In some embodiments, the one or more work-zone related objects are selected from traffic cones, barricades, barrels, chain fences, construction vehicles, signs, or workers.

In some embodiments, the method includes the step of obtaining images of the work zone from traffic cameras, web-mined images, or synthetic work zone images generated by a 3D simulator.

In some embodiments, the method includes the step of estimating the work zone size using the established scale. In some embodiments, the step of estimating the work zone size includes dividing the image of the identified work zone into hyper-planes oriented perpendicularly to the horizontal plane, calculating the real-to-pixel distance ratios for each hyper-plane, and estimating the work zone size based on known sizes of common work zone equipment.

In some embodiments, the method includes the step of training a machine learning model by iteratively augmenting a training dataset with additional images of work zones.

Aspects of the present invention relate to a system for work zone size estimation having a non-transitory computer-readable medium with instructions stored thereon, which when executed by a processor, performs any disclosed methods or steps thereof.

### BRIEF DESCRIPTION OF THE DRAWINGS

The following detailed description of embodiments of the invention will be better understood when read in conjunction with the appended drawings. It should be understood, however, that the invention is not limited to the precise arrangements and instrumentalities of the embodiments shown in the drawings.

FIG. 1 is a diagram of a generic computing device for practicing the various embodiments of the invention.

FIG. 2 is a flowchart depicting an exemplary method for work zone management comprising urban work zone estimation, detection and/or sizing according to aspects of the present invention.

FIG. 3 is a diagram depicting an exemplary Data-Centric training pipeline used in the disclosed system and method according to aspects of the present invention.

FIG. 4 is a diagram depicting various steps and features for an exemplary method for work zone management comprising work zone size estimation according to aspects of the present invention.

FIGS. 5A through 5D are plots displaying precision-recall (PR) curves of model validation from baseline model, and data-centric (DC) trained models using different training data sources combinations.

FIGS. 6A-6D are images depicting exemplary screens of a graphical user interface (GUI) comprising images of work zones displaying the output of work zone detection, inference, and area estimation. FIGS. 6A & 6B highlight detected work zones in orange, with estimated sizes at the bottom right. FIGS. 6C & 6D show correct detection of non-work zones that contain work zone equipment.

FIG. 7 is a series of images depicting exemplary steps for a method for work zone management comprising urban work zone detection and simulation according to aspects of the present invention.

FIG. 8 is a flowchart depicting an exemplary method for work zone management comprising urban work zone detection and sizing according to aspects of the present invention.

FIGS. 9A through 9E are images depicting an exemplary GUI for a work zone management system comprising work zone detection and sizing according to aspects of the present invention. FIG. 9A depicts an exemplary dashboard for the GUI.

FIG. 9B depicts an exemplary navigation bar for the dashboard. FIG. 9C depicts exemplary widgets shown in the content area of the dashboard. FIGS. 9D and 9E are images depicting exemplary widgets comprising plots and historical data.

FIGS. 10A & 10B are images depicting exemplary widgets for the dashboard comprising a map view with selected work zone images displayed adjacent to the map view.

FIGS. 11A & 11B are images depicting exemplary widgets for the dashboard comprising a map view with various metrics (e.g., safety, speed of vehicles, etc.) and reporting abilities.

FIG. 12 is an image depicting an exemplary widget for the dashboard comprising a traffic detection module or toolbox for the UI allowing a user to upload an image for work zone identification, detection and/or size estimation according to aspects of the present invention.

### DETAILED DESCRIPTION

The disclosed system and method for work zone management provide an efficient and accurate framework that can autonomously identify work zones in complex urban environments and estimate their sizes in real-time. By harnessing the power of deep learning, topology analysis, and innovative size estimation techniques, the disclosed framework bridges the gap in acquiring real-time work zone data and empowers various transportation management systems to proactively manage work zone-related activities (e.g., traffic speed, traffic disruptions).

It is to be understood that the figures and descriptions of the present invention have been simplified to illustrate elements that are relevant for a clear understanding of the present invention, while eliminating, for the purpose of clarity many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

### Definitions

Unless defined otherwise, all technical and scientific terms used herein have the same meaning as commonly understood by one of ordinary skill in the art to which the invention pertains. Although any methods and materials similar or equivalent to those described herein can be used in the practice for testing of the present invention, exemplary materials and methods are described herein. In describing and claiming the present invention, the following terminology will be used.

It is also to be understood that the terminology used herein is for the purpose of describing particular embodiments only, and is not intended to be limiting.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, or ±0.1% from the specified value, as such variations are appropriate.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### Computing Device

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled, or interpreted, including but not limited to C, C++, C#, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

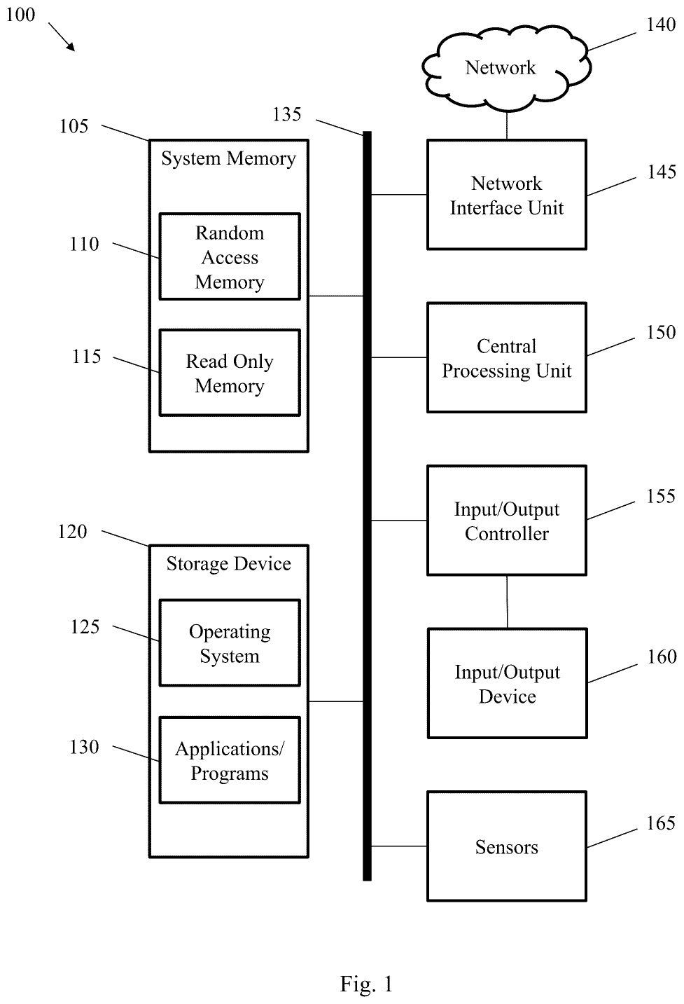

FIG. 1 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 1 depicts an illustrative computer architecture for a computer 100 for practicing the various embodiments of the invention. The computer architecture shown in FIG. 1 illustrates a conventional personal computer, including a central processing unit 150 (“CPU”), a system memory 105, including a random access memory 110 (“RAM”) and a read-only memory (“ROM”) 115, and a system bus 135 that couples the system memory 105 to the CPU 150. A basic input/output system containing the basic routines that help to transfer information between elements within the computer, such as during startup, is stored in the ROM 115. The computer 100 further includes a storage device 120 for storing an operating system 125, application/program 130, and data.

The storage device 120 is connected to the CPU 150 through a storage controller (not shown) connected to the bus 135. The storage device 120 and its associated computer-readable media provide non-volatile storage for the computer 100. Although the description of computer-readable media contained herein refers to a storage device, such as a hard disk or CD-ROM drive, it should be appreciated by those skilled in the art that computer-readable media can be any available media that can be accessed by the computer 100.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 100 may operate in a networked environment using logical connections to remote computers through a network 140, such as TCP/IP network such as the Internet or an intranet. The computer 100 may connect to the network 140 through a network interface unit 145 connected to the bus 135. It should be appreciated that the network interface unit 145 may also be utilized to connect to other types of networks and remote computer systems.

The computer 100 may also include an input/output controller 155 for receiving and processing input from a number of input/output devices 160, including a keyboard, a mouse, a touchscreen, a camera, a microphone, a controller, a joystick, or other type of input device. Similarly, the input/output controller 155 may provide output to a display screen, a printer, a speaker, or other type of output device. The computer 100 can connect to the input/output device 160 via a wired connection including, but not limited to, fiber optic, Ethernet, or copper wire or wireless means including, but not limited to, Wi-Fi, Bluetooth, Near-Field Communication (NFC), infrared, or other suitable wired or wireless connections.

As mentioned briefly above, a number of program modules and data files may be stored in the storage device 120 and/or RAM 110 of the computer 100, including an operating system 125 suitable for controlling the operation of a networked computer. The storage device 120 and RAM 110 may also store one or more applications/programs 130. In particular, the storage device 120 and RAM 110 may store an application/program 130 for providing a variety of functionalities to a user via a user interface (UI) and/or graphical user interface (GUI). For instance, the application/program 130 may comprise many types of programs such as a word processing application, a spreadsheet application, a desktop publishing application, a database application, a gaming application, internet browsing application, electronic mail application, messaging application, and the like. According to an embodiment of the present invention, the application/program 130 comprises a multiple functionality software application for providing word processing functionality, slide presentation functionality, spreadsheet functionality, database functionality and the like.

The computer 100 in some embodiments can include a variety of sensors 165 for monitoring the environment surrounding and the environment internal to the computer 100. These sensors 165 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

Aspects of the invention relate to machine learning executed on a computing device, wherein the computing device may be computer 100. Machine learning is a type of artificial intelligence (AI) that provides systems the ability to learn and improve from experience without being explicitly programmed. Machine learning utilizes algorithms to analyze data sets and identify correlations and patterns, and then uses those patterns to make predictions and decisions. In general, machine learning models fall into three primary categories: supervised machine learning, unsupervised machine learning and semi-supervised machine learning.

Supervised learning, is defined by its use of labeled datasets to train algorithms to classify data or predict outcomes accurately. As input data is fed into the model, the model adjusts its weights until it has been fitted appropriately. Some methods used in supervised learning include neural networks, naïve bayes, linear regression, logistic regression, random forest, and support vector machine (SVM).

Unsupervised learning, uses machine learning algorithms to analyze and cluster unlabeled datasets. These algorithms discover hidden patterns or data groupings without the need for human intervention. Principal component analysis (PCA) and singular value decomposition (SVD) are two common approaches for this. Other algorithms used in unsupervised learning include neural networks, k-means clustering, and probabilistic clustering methods.

Semi-supervised learning offers a medium ground between supervised and unsupervised learning. During training, semi-supervised learning uses a smaller labeled data set to guide classification and feature extraction from a larger, unlabeled data set.

Classification is a part of supervised learning (learning with labeled data) through which data inputs can be easily separated into categories. In machine learning, there can be binary classifiers with only two outcomes (e.g., spam, non-spam) or multi-class classifiers (e.g., types of books, animal species, etc.). A popular classification algorithm is a decision tree whereby repeated questions leading to precise classifications can build an “if-then” framework for narrowing down the pool of possibilities over time.

Clustering is a form of unsupervised learning (learning with unlabeled data) that involves grouping data points according to features and attributes. The most common kind of clustering is K-means clustering, which involves representing each cluster by a variable “k” and then defining the centroid of those clusters.

Regression is a type of structured machine learning algorithm where we can label the inputs and outputs. Linear regression provides outputs with continuous variables (any value within a range), such as pricing data. Logistical regression is when variables are categorically dependent and the labeled variables are precisely defined. For example, you can classify whether a store is open as (1) or (0), but there are only two possibilities.

Deep learning is an application of machine learning that imitates the workings of the human brain. Deep learning networks interpret big data, both unstructured and structured, and recognize patterns. Neural networks are closely related to deep learning, they create sequential layers of neurons that deepen the understanding of data collected from a machine to provide an accurate analysis. A neural network consists of layers of nodes, having neurons, which receive stimulation from “trigger” data. This data then is assigned a weight through coefficients, as some data inputs may be more significant than others. Neurons normally come in three different layers: an input layer of data, a hidden layer with mathematical computations, and an output layer.

### System and Method for Work Zone Management

Aspects of the present invention relate to a system and method for work zone management comprising work zone identification, detection and/or sizing. In some embodiments, the disclosed system and method comprise a deep-learning based work zone object detection model with a data-centric approach to work zone management. In some embodiments, the disclosed system and method comprise a novel framework that combines a data-centric approach to training deep learning models, topology-based inference for scene recognition, and a reference-free method for work zone management (e.g., work zone size estimation). In some embodiments, the disclosed system and method systematically augment training datasets with data from diverse sources, consider the spatial relationships among work zone objects, and leverage standard equipment heights for size estimation. The disclosed system and method significantly advance the capabilities of automated work zone management (e.g., urban work zone detection and sizing).

In some embodiments, the system and method comprise or utilize a deep learning based framework to effectively recognize urban work zone scenes and provide a size estimation of the work zone scene. In some embodiments, the system and method comprise or utilize a data-centric training method designed to iteratively improve the performance of work zone object detection by augmenting a customized training dataset fused from multiple data sources to overcome the sparsity of annotated real-world work zone images. In some embodiments, these multiple data sources include 2,600 images with 15,000 work zone object labels from traffic cameras, web-mined images, and synthetic work zone images generated through a 3D simulator.

In some embodiments, the system and method comprise or utilize a topology-based inference method implemented using XGBoost to automatically identify work zone scenes. This innovative approach is designed to deal with the complexities of work zone scene detection caused by the fact that recognizing individual or certain combination of work zone components alone (e.g., a traffic cone behind a car) may not necessarily represent a true work zone. In some embodiments, the system and method comprise or utilize a reference-free work zone size estimation method, which uses the standard heights of common work zone equipment to provide a generalized real-pixel distance rate calculation method for efficiently and accurately sizing work zone related objects and work zone size.

Aspects of the present invention relate to a system and method for work zone management (e.g., urban work zone detection and sizing) comprising a data-centric framework. In some embodiments, the framework comprises three modules or methods: a data-centric training module or method that systematically augments training datasets with the goal of enhancing the accuracy of the work zone detection model, a topology-based work zone scene inference module or method that can identify work zones by understanding the positional relationships and connections among detected work zone objects (e.g., cones placed adjacent to a line of fences), and a reference-free estimation module or method for work zone size estimation.

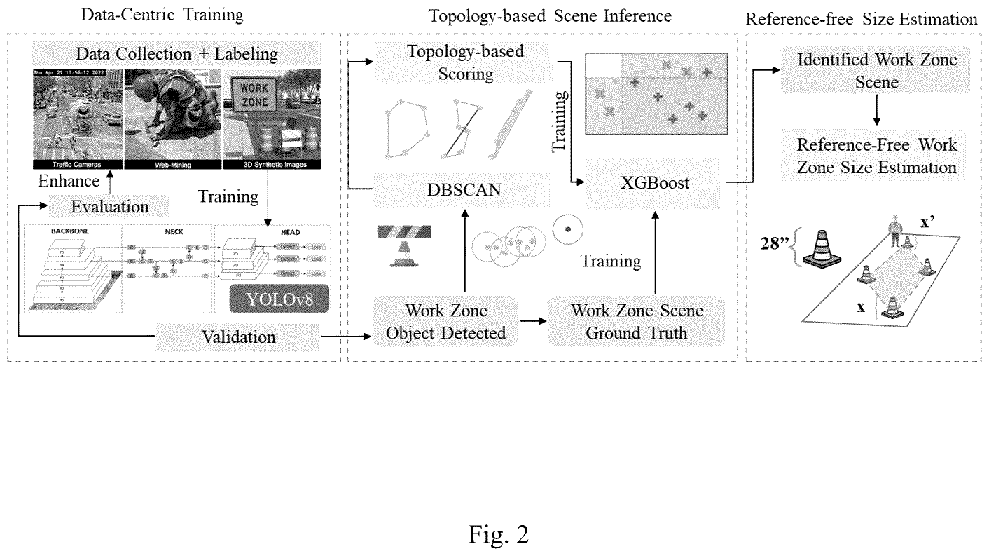

Referring now to FIG. 2, shown is a flowchart depicting an exemplary method for work zone management comprising urban work zone estimation, detection and/or sizing according to aspects of the present invention. FIG. 2 depicts exemplary steps (e.g., a working flow) for the system and method disclosed herein. In some embodiments, the data-centric training module or method for work zone object detection comprises collecting a customized dataset of 2,600 work zone images with approximately 15,000 labels from diverse sources including CCTVs, and/or web-mined images. In some embodiments, the disclosed system and method comprises a 3D simulator (e.g., an open-source 3D simulator), offering or producing a wide array of simulated or synthetic work zone scenarios (see simulated work zone scenes in FIGS. 2 & 4). In some embodiments, the system and method is configured to identify several key work zone objects, such as traffic cones, construction workers and vehicles. In some embodiments, web-mined and 3D synthetic or simulated images primarily serve to fill the gaps in certain subcategories of the training data, which may be sparse in the CCTV images. For example, in some embodiments, web-mining is used as a supplemental source for augmenting training images for construction vehicles. In some embodiments, the quality of the data is incrementally improved by correcting label errors and pruning noisy labels based on data quality objectives.

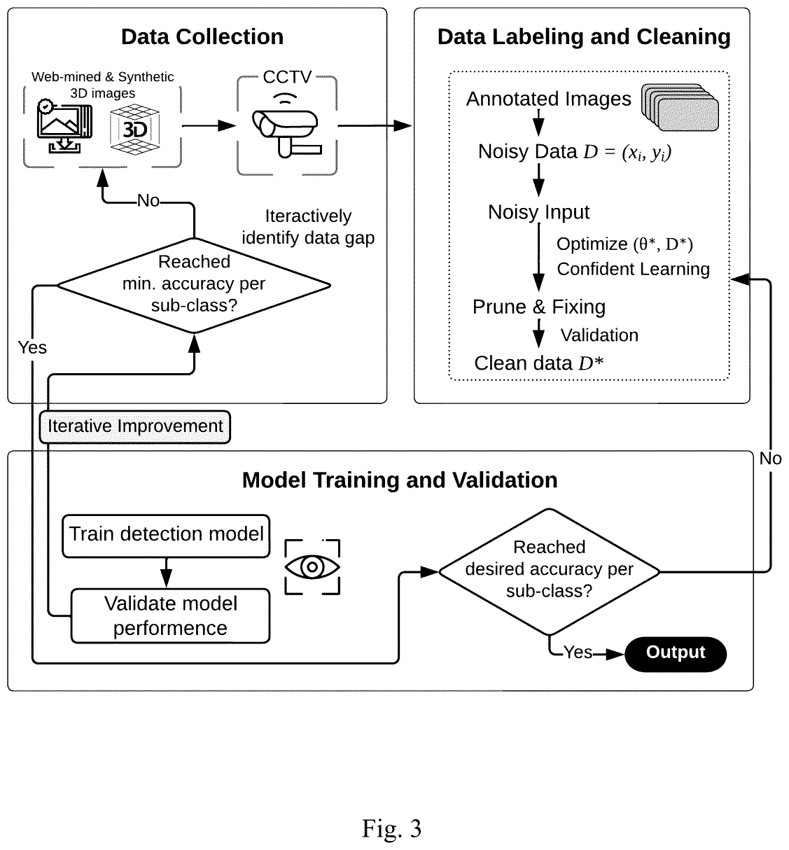

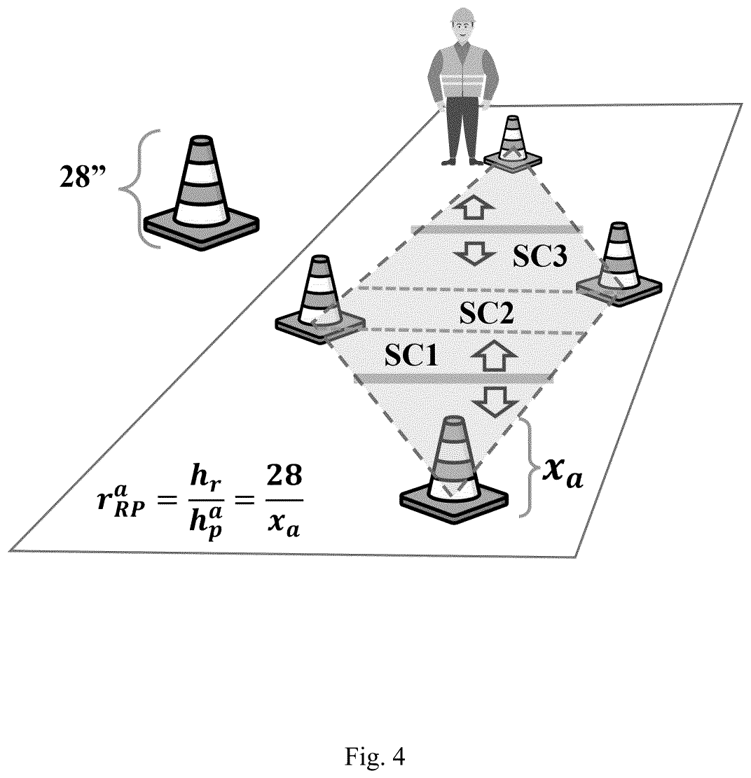

FIG. 3 is a diagram depicting an exemplary Data-Centric training pipeline used in the disclosed system and method according to aspects of the present invention. FIG. 4 is a diagram depicting various steps and features for an exemplary method for work zone management comprising work zone size estimation according to aspects of the present invention.

Aspects of the present invention relate to a system and method for work zone management comprising topology-based work zone inference, detection, and/or identification. In some embodiments, the topology-based work zone inference method comprises the step of analyzing the topological arrangement of the identified work zone objects. In some embodiments, the method comprises calculating a topology complexity score based on the positional relationships and connections among the work zone objects. In some embodiments, the score serves as an indicator of whether the scene represents an organized work zone or a random accumulation of work zone objects for non-work zone purpose. In some embodiments, the score is then fed into a machine learning algorithm (e.g., an XGBoost classifier), which is trained on ground truth work zone scene data.

Aspects of the present invention relate to a system and method for work zone management comprising a reference-free work zone size estimation. In some embodiments, the system and method comprises or utilizes an estimation algorithm performed to approximate the size of the work zone. In some embodiments, the estimation is accomplished using a reference-free method, which utilizes the standard heights of common work zone equipment to establish a scale, eliminating the need for manual measurements in the real world. In some embodiments, with this scale, the distances and sizes of the work zone scene can be calculated, allowing for an estimation of the work zone's size.

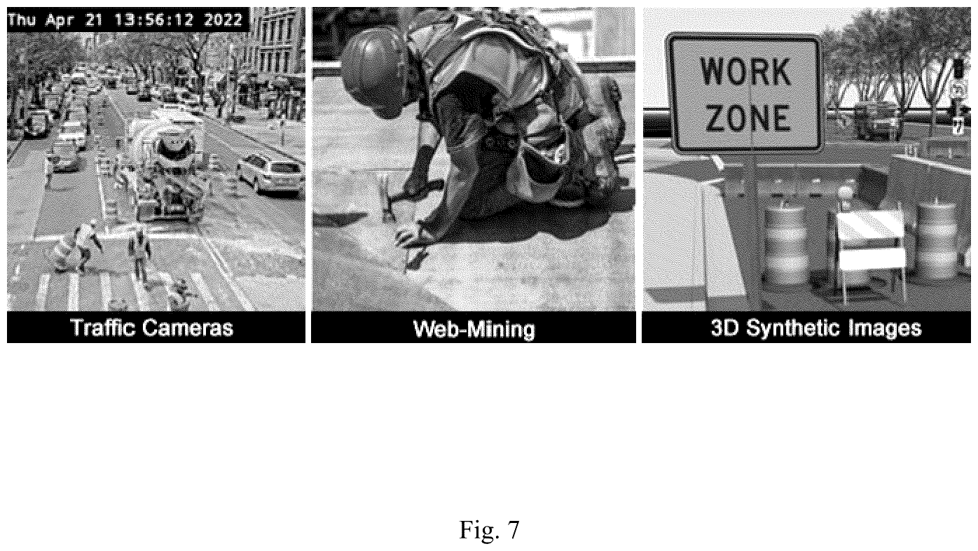

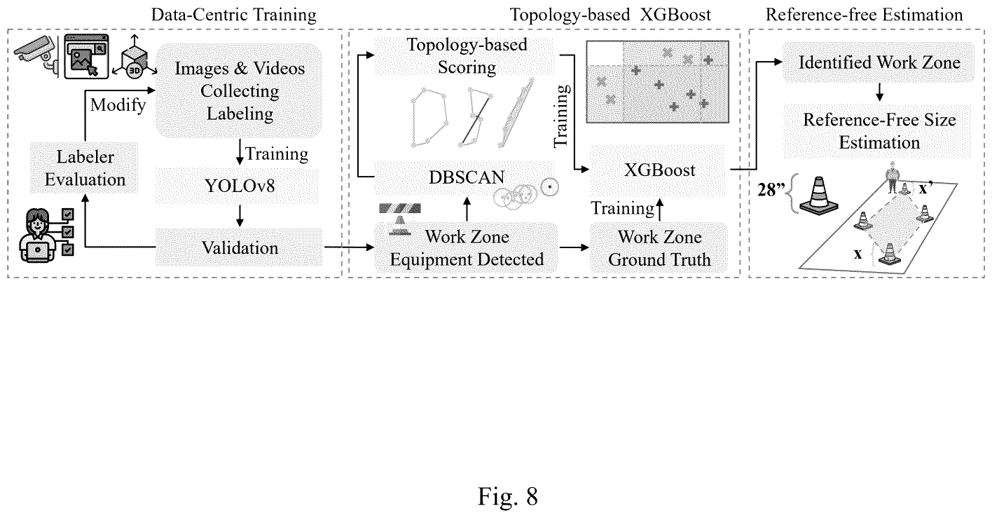

Aspects of the present invention relate to a system and method for work zone management comprising work zone detection using a data-centric training pipeline. FIG. 7 is a series of images depicting exemplary steps for a method for work zone management comprising urban work zone detection and simulation according to aspects of the present invention. In some embodiments, the steps comprise using data or feeds from traffic cameras, web-mining work zone related data, and producing a 3D synthetic image or simulation of the work zone. FIG. 8 is a flowchart depicting an exemplary method for work zone management comprising a data-centric training comprising the steps of collecting and labelling images and videos, training a machine learning algorithm with a computer vision model (e.g., YOLOv8) based on the collected images and videos, validating the training of the machine learning algorithm, and optionally evaluating the labeler or labeling, and modifying the labelling based on the evaluation. In some embodiments, the method comprises detecting work zone equipment or objects in the collected images and videos. In some embodiments, the method comprises processing the data of detected work zone equipment or objects with a clustering algorithm (e.g., Density-Based Spatial Clustering of Applications with Noise (DBSCAN). In some embodiments, the method comprises a topology-based scoring based on detected work zone equipment and the results of the clustering algorithm (e.g., DBSCAN). In some embodiments, the method comprises providing the scores from the topology-based scoring into a decision tree machine learning library (Extreme Gradient Boosting (XGBoost)). In some embodiments, the decision tree machine learning library is trained with work zone ground truth data. In some embodiments, the method comprises identifying or detecting one or more work zones based on the output or results of the decision tree machine learning library (e.g., XGBoost). In some embodiments, the method comprises a reference-free work zone size estimation based on the identified work zones and work zone equipment or objects. In some embodiments, the disclosed system or method outputs one or more images or videos (e.g., a live stream with informational overlays) of the identified work zones.

The key of work zone detection and sizing lies in accurately recognizing work zone-related objects. In some embodiments, the disclosed system and method focuses on certain key work zone equipment and/or objects, including, but not limited to, traffic cones, barricades, barrels, chain fences, construction vehicles, signs, pedestrians, parked cars, and/or workers.

In some embodiments, the disclosed system and method comprise or utilize a computer vision model or algorithm (e.g., YOLOv8 model) that integrates cutting-edge backbone and neck architectures with the mosaic augmentation for both feature extraction and object detection [G. Jocher, A. Chaurasia, and J. Qiu, “Yolo by ultralytics,” 2023. [Online]. Available: https://github.com/ultralytics/ultralytics]. In some embodiments, the system and method further comprise or utilize a curated and manually labeled training set featuring work zone objects from the sources (collected images and videos), as depicted in FIG. 2.

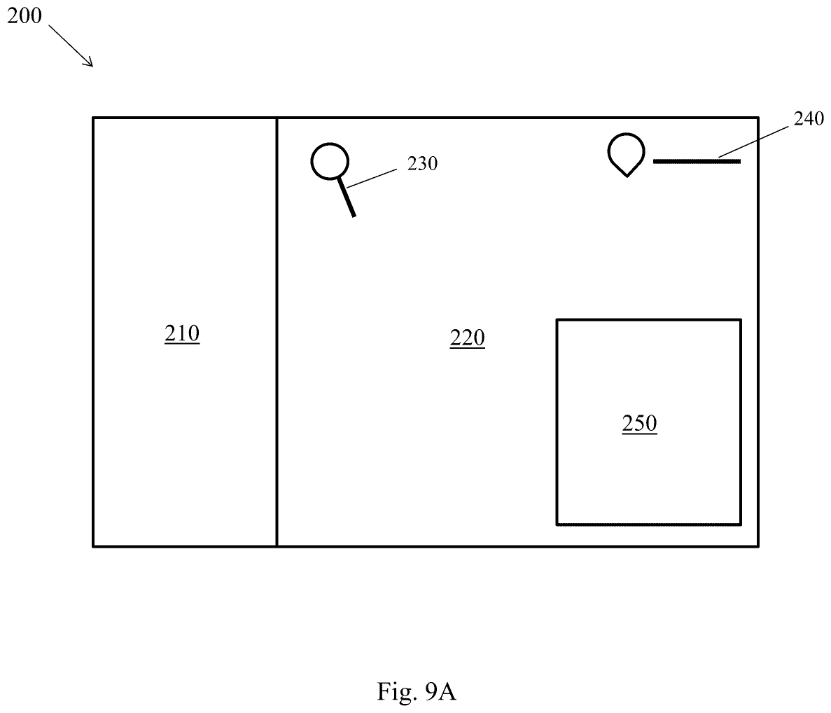

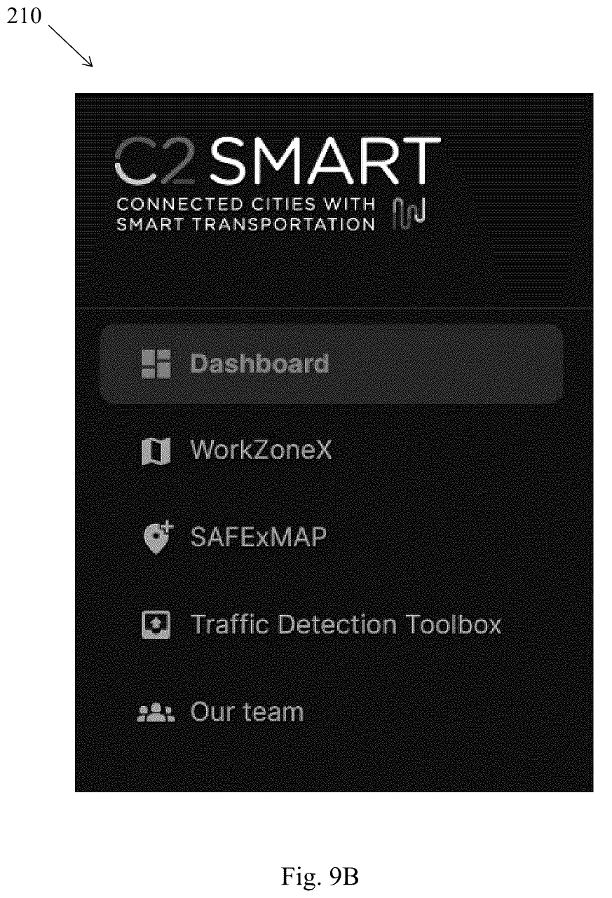

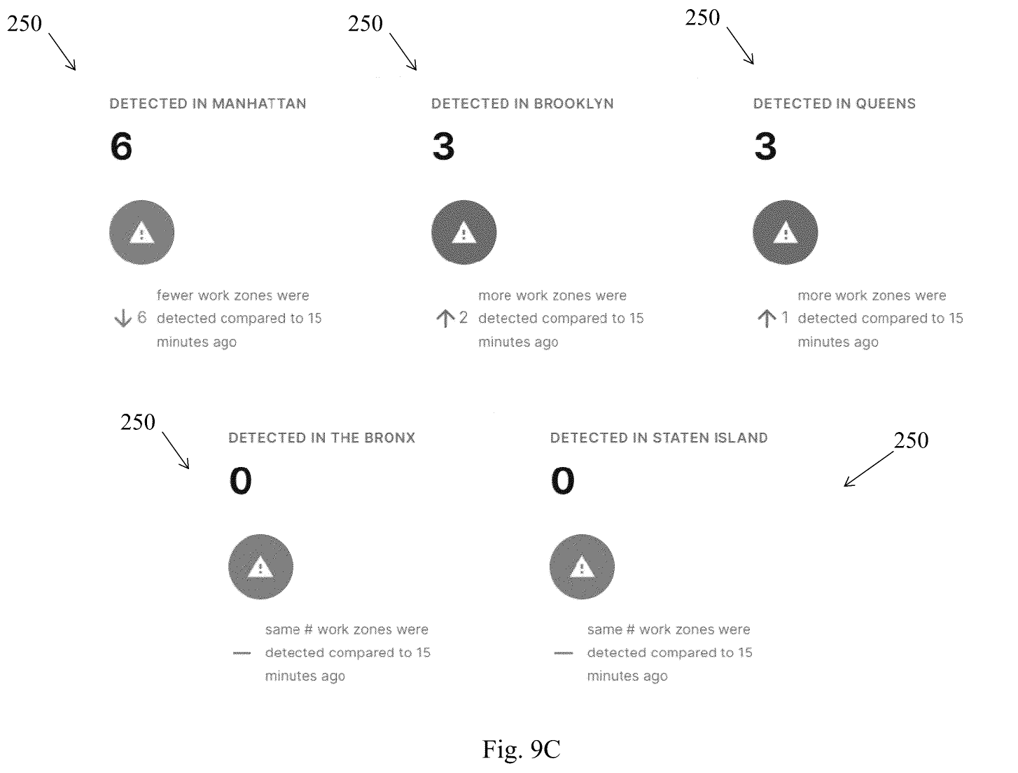

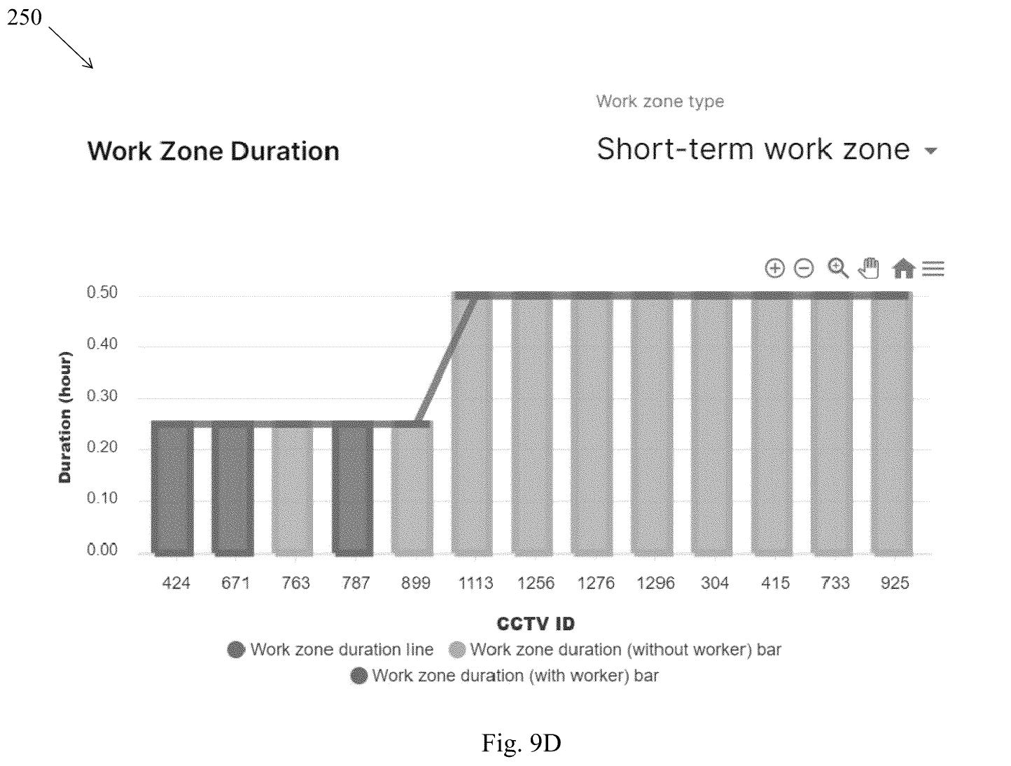

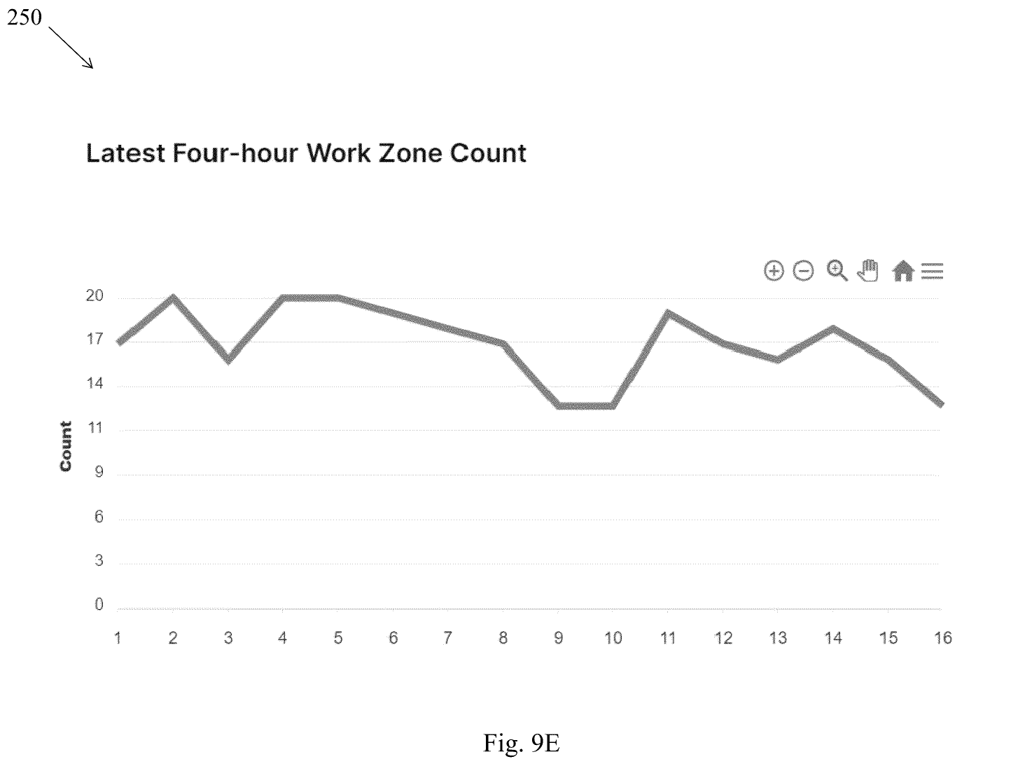

Aspects of the present invention relate to a user interface (UI) which may comprise a graphical user interface (GUI) for accessing or using the disclosed system and method for work zone management. The GUI generally comprises a dashboard view with various screens, features and modules that may be opened, selected and/or modified (See FIG. 9A for an exemplary GUI comprising a dashboard 200).

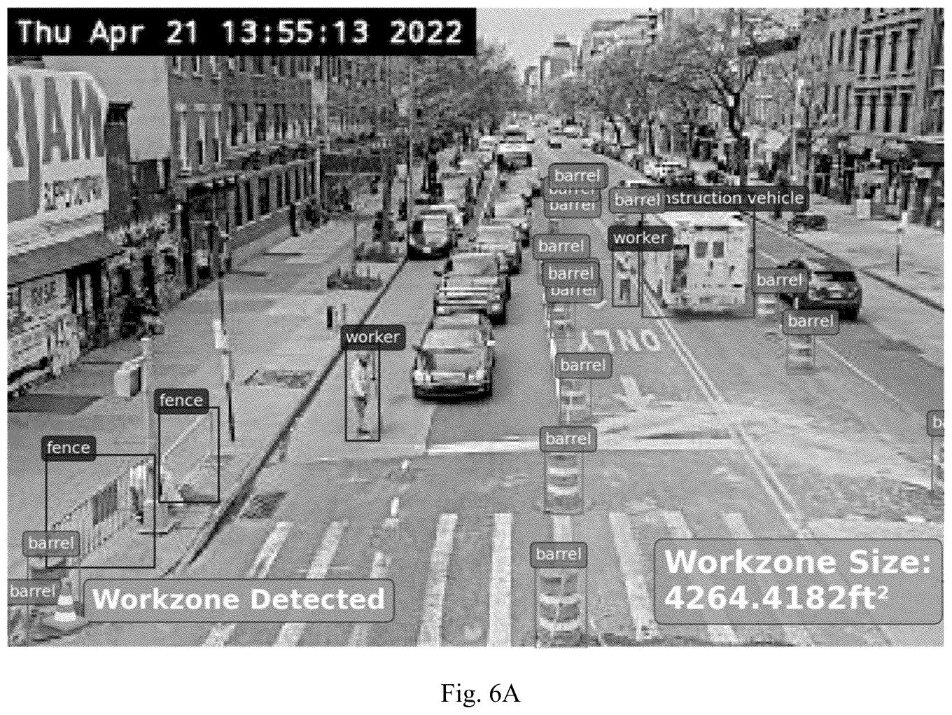

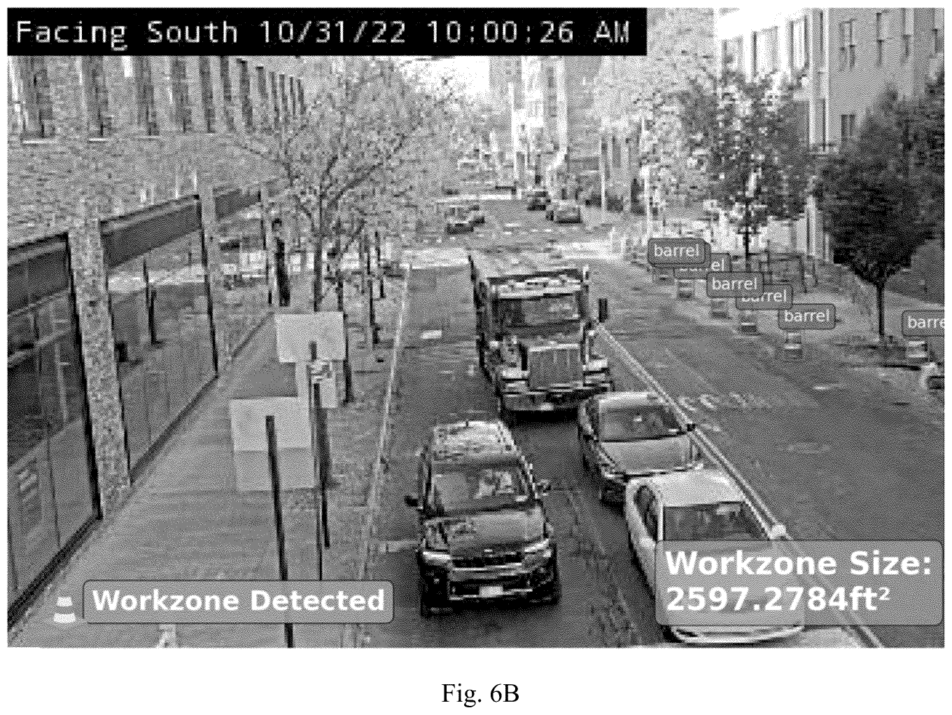

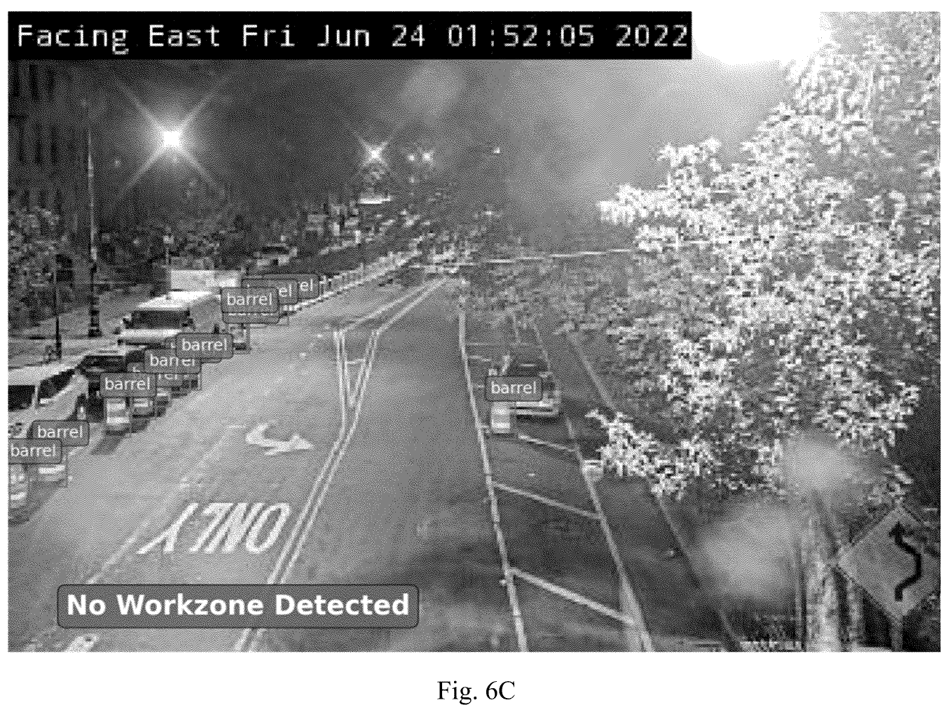

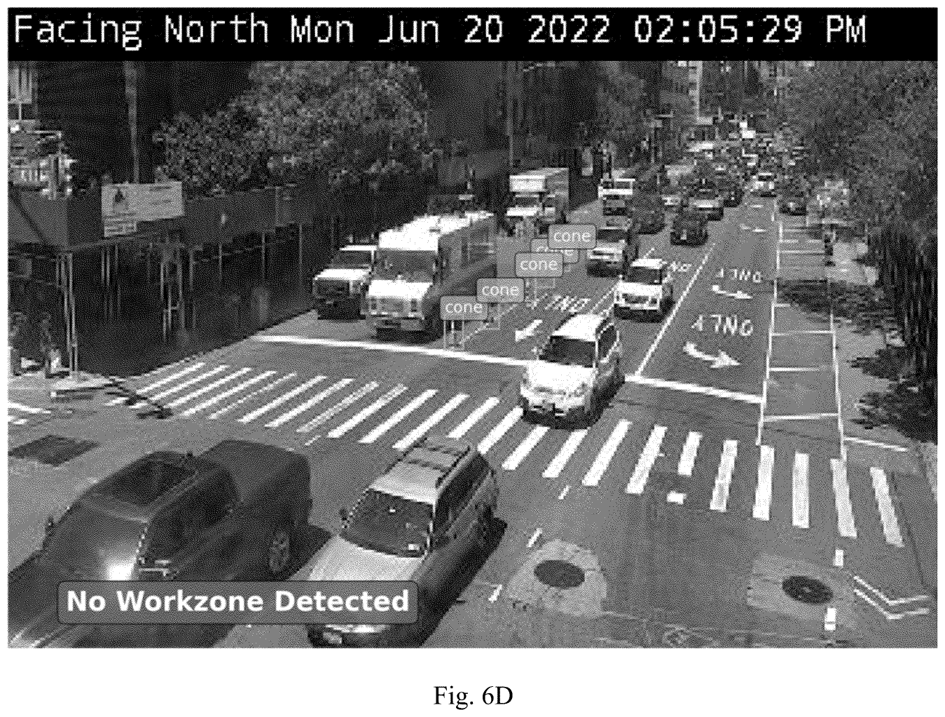

Referring now to FIGS. 6A through 6D, shown are exemplary screens or widgets for the GUI displaying a plurality of work zones to the user. In some embodiments, the displayed work zones are sourced from live camera feeds. In some embodiments, the work zone is displayed with overlays and/or work zone objects highlighted over a live camera feed. In some embodiments, the user highlights, selects or bounds a work zone or area of interest using the GUI. In some embodiments, the size or area of the highlighted work zone or area of interest is shown in the GUI (e.g., in a graphical box). In some embodiments, the user selects one or more work zone objects in an area of interest to pre-define a work zone. In some embodiments, the GUI automatically detects work zone objects and highlights a proposed work zone. In some embodiments, the GUI provides work zone location and metrics, and an indicator for detection (presence or absence) of a work zone (e.g., in a graphical box). In some examples, the disclosed system may be referred to as “WorkZoneX” as described herein, and shown in FIGS. 9A through 12.

FIGS. 9A through 12 are images depicting aspects of an exemplary GUI for a work zone management system comprising work zone detection and sizing according to aspects of the present invention. FIG. 9A depicts an exemplary dashboard 200 for the GUI comprising a navigation bar 210 and content area 220. In some embodiments, dashboard 200 further comprises a search tool 230 and location tool 240. FIG. 9B depicts an exemplary layout for a navigation bar 210 displaying exemplary tabs comprising one or more widgets. In some embodiments, dashboard 200 provides tabs with organized widgets, modules, alerts, and/or reports displayed in content area 220 of the GUI that give insight into one or more work zones (e.g., such as the work zones depicted in FIGS. 6A-6D). For example, the GUI may provide one or more widgets 250 displaying work zone information such as active number of work zones detected in one or more areas (e.g., a specific city, region, and/or state) (as shown in FIG. 9C through FIG. 9E). The active number of work zone widgets may further provide alerts, trend analysis, reporting, and the like. In some embodiments, the UI displays analytics, reports, and/or plots for work zone metrics such as work zone duration, and work zone duration with and without workers. (see FIGS. 9D & 9E) In some embodiments, the GUI displays a report or plot for total number of detected work zones over a period of time for one or more areas.

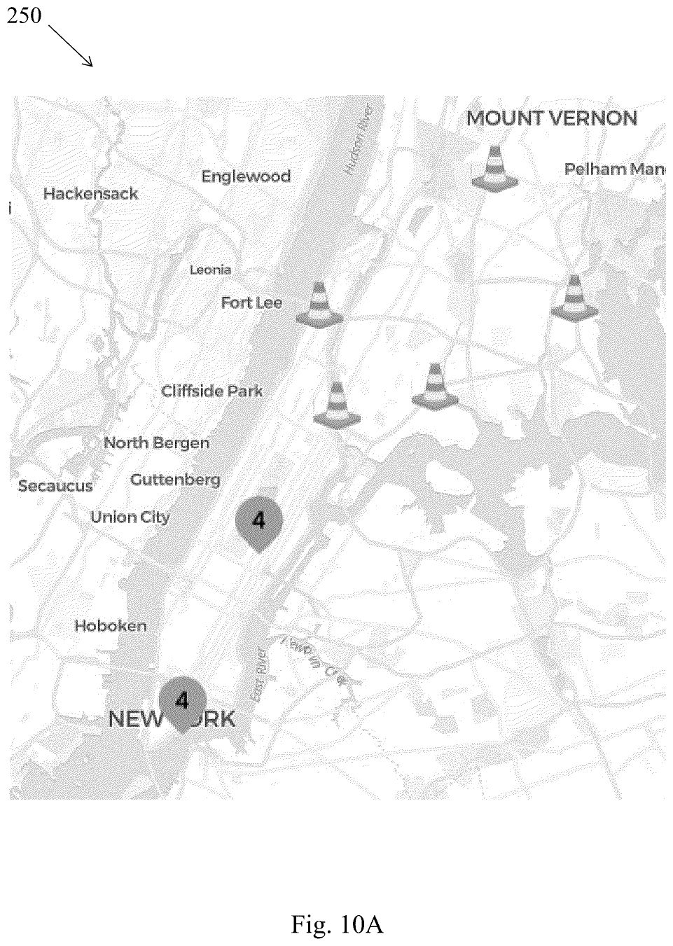

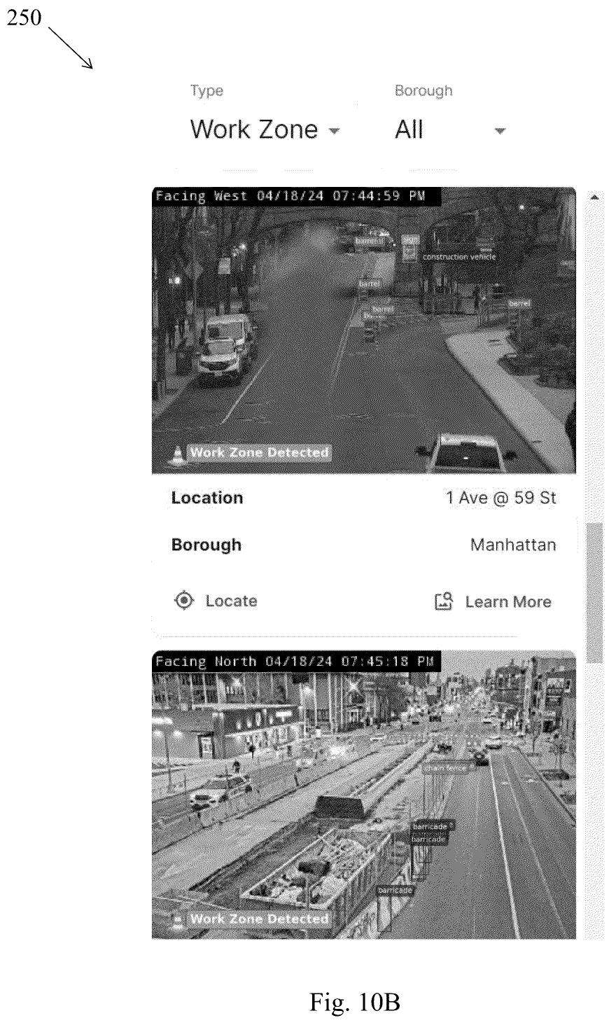

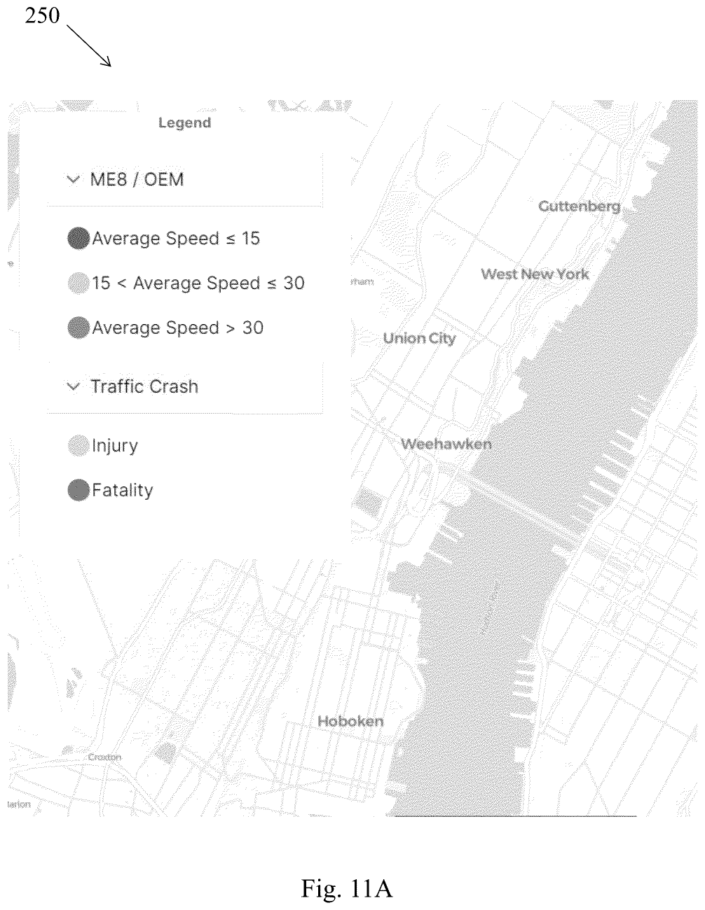

FIGS. 10A & 10B show portions of an exemplary widget 250 comprising a map view for the GUI with images or feeds of selected work zones displayed adjacent to the map. In some embodiments, the map view comprises geolocational pins representative of one or more work zones in one or more areas. In some embodiments, the geolocational pins indicate clusters of active work zones across the one or more areas. In some embodiments, zooming in on the geolocational pins reveals individual work zones that may be selected, thereby displaying or enlarging an image or feed of the work zone (as shown in FIG. 10B).

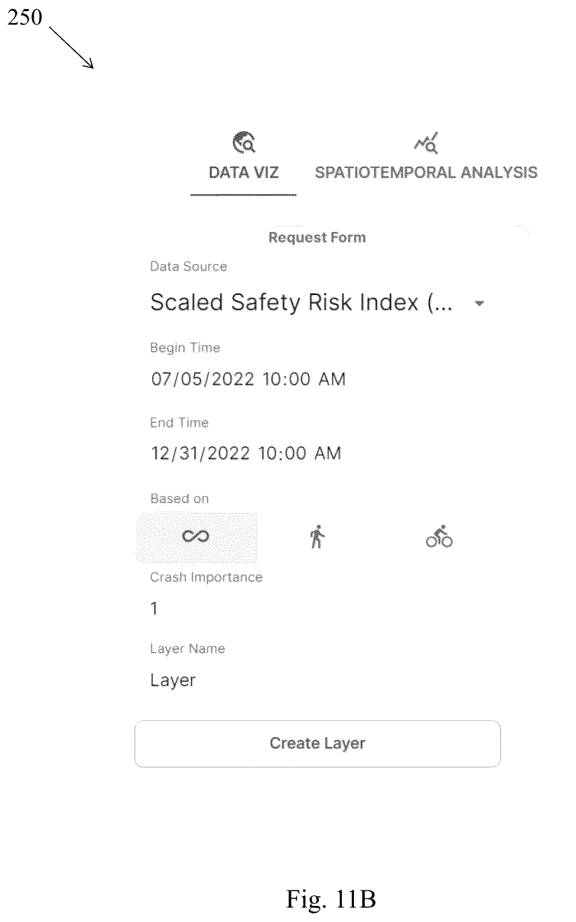

FIGS. 11A & 11B show portions of an exemplary widget 250 comprising a map view for the GUI with various traffic and work zone metrics reporting (e.g., safety, speed of vehicles, vehicle accidents, etc.) presented as a map view or a report. In some embodiments, the GUI displays a map view providing data visualization and spatiotemporal analysis of various safety-related data, including traffic data, traffic-safety data, historical data, work zone data, vehicle accident data, road hazard data, traffic ticketing data, camera data, public camera data, and the like. In some embodiments, the map view, or a work zone report produced by the UI, may include data from one or more data sources related to traffic crashes, near misses, speeding tickets, construction zones, pedestrians/cyclists on high speed roads, hazards on roads, vehicles stopped on road shoulders, scaled safety risk index (SSRI)), and any combinations thereof. In some embodiments, a duration or time period may be set for the map view and/or report. In some embodiments, the type of traffic may be selected for the map view or report, such as all traffic, bicycle traffic, pedestrian traffic, vehicle traffic, car traffic, and truck traffic.

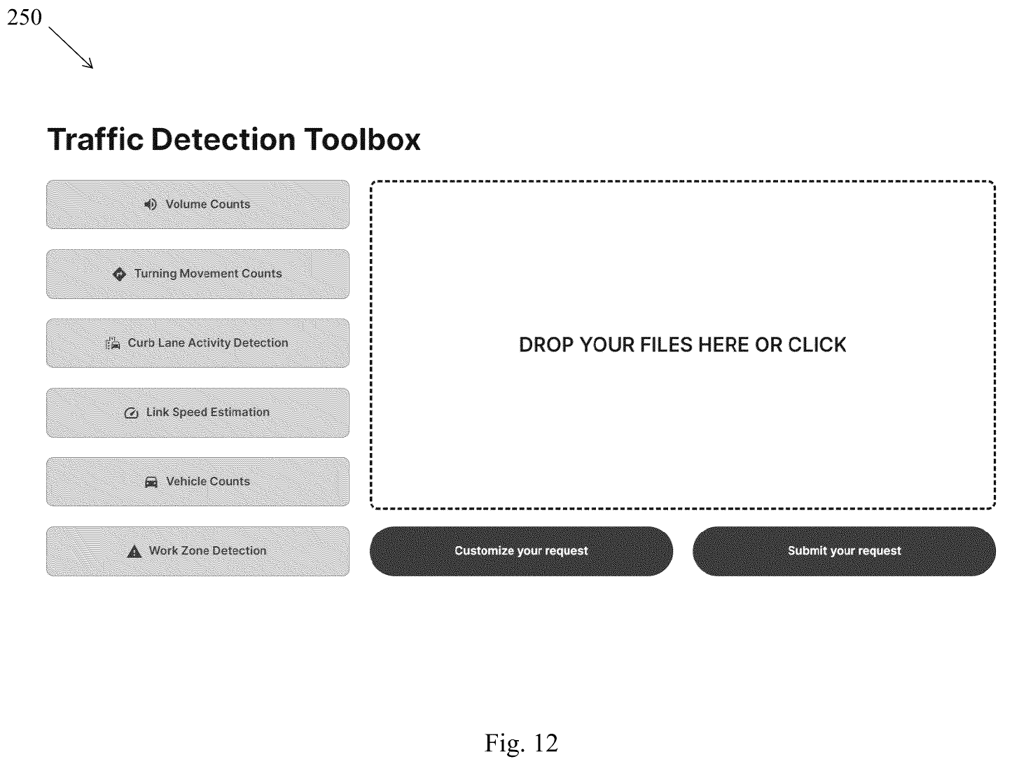

FIG. 12 depicts an exemplary widget 250 comprising a traffic detection module or toolbox for the UI allowing a user to upload an image (or feed) for work zone identification, detection and/or size estimation according to aspects of the present invention. In some embodiments, the UI produces a report based on the uploaded image or video (or camera feed). In some embodiments, the settings for the report may be modified with various detection and estimation settings such as volume counts, turning movement counts, curb lane activity detection, link speed estimation, pedestrian count, and work zone detection.

Volume Counts: This feature counts the number of vehicles passing through a specific area within a certain time period. In some embodiments, the user draws a line or box as an indicator of a detection line/region in the video, and the UI produces a count of the volume of vehicles that pass through or enter the line/box.

Pedestrian Counts: This feature detects and counts the number of pedestrians in a given area within a certain time period. In some embodiments, the user draws or sets an indicator line or box in the video, and the UI produces a count of the volume of pedestrians that pass through or enter the indicator line or box.

Turning Movement Counts: This feature allows the detection and counting of vehicles making specific turning movements (e.g., left, right turns) at intersections. In some embodiments, the user draws or sets a start indicator line/box and an end indicator line/box for each type of turn in the video (e.g., a set of indicator lines/boxes), and the UI counts or produces a count of the turning movements of vehicles that enter or pass through the specific indicator line/box set.

Curb Lane Activity Detection: This feature monitors the curb lanes for activities such as parking, loading/unloading, or stopping. In some embodiments, the user draws or sets the detection region of one or more curb lanes (e.g., a bounding box in the video area), and the UI identifies the objects appearing in the detection region.

Link Speed Estimation: This feature detects and estimates the average speed of vehicles on a particular road link or section. In some embodiments, the user sets a start indicator line/box and an end indicator line/box in the video (e.g., a set of indicator lines/boxes), and the UI tracks each vehicle and estimates the average link speed of each vehicle (or an average of all the vehicles) flowing between and/or passing through the specific indicator line/box set.

Aspects of the present invention relate to a method for work zone management (e.g., work zone identification), comprising the steps of providing one or more images of a work zone, analyzing the one or more images to detect one or more work-zone related objects within the work zone, sizing the detected work-zone related objects by comparing the detected objects to known sizes of common work zone equipment to establish a scale, calculating estimated positions of the one or more work-zone related objects, mapping the one or more work-zone related objects to a topological map, calculating a topology complexity score based on the topological map, determining whether the work zone is an organized work zone or a random accumulation of work zone objects, based on the topology complexity score.

Aspects of the present invention relate to a method for work zone management (e.g., work zone size estimation) or real-time traffic management comprising, providing a weighted graph of roads in a locality comprising a plurality of nodes and a plurality of edges connecting the nodes, each node representing an intersection and each edge representing a road, providing one or more images of a work zone in the locality, analyzing the one or more images to detect one or more work-zone related objects within the work zone, calculating estimated positions of the one or more work-zone related objects using known approximate sizes of the work-zone related objects, mapping the one or more work-zone related objects to a topological map, calculating an estimated work zone size based on the topological map, calculating a topology complexity score based on the topological map, adjusting a weight of at least one edge in the weighted graph based on the calculated size and topology complexity score and providing the updated weighted graph to a database in real time.

In some embodiments, the step of mapping the one or more work-zone related objects to a topological map comprises detecting and recording the inter-connectedness of the one or more work-zone related objects within the work zone. In some embodiments, the step of calculating a topology complexity score comprises utilizing density-based clustering algorithms to group the detected work zone related objects and calculating the score based on the resulting graph features.

In some embodiments, the one or more work-zone related objects are selected from traffic cones, barricades, barrels, chain fences, construction vehicles, signs, or workers. In some embodiments, the method further comprises the step of obtaining images of the work zone from traffic cameras, web-mined images, or synthetic or simulated work zone images generated by a 3D simulator.

In some embodiments, the method further comprises the step of estimating the work zone size using the established scale. In some embodiments, the step of estimating the work zone size further comprises dividing the image of the identified work zone into hyper-planes oriented perpendicularly to the horizontal plane, calculating the real-to-pixel distance ratios for each hyper-plane, and estimating the work zone size based on known sizes of common work zone equipment.

In some embodiments, the method further comprises the step of training a machine learning model by iteratively augmenting a training dataset with additional images of work zones.

In some aspects, the present invention relates to a system for work zone management, identification, detection, and/or sizing comprising a non-transitory computer-readable medium with instructions stored thereon (e.g., computer 100), which when executed by a processor, performs the steps of any disclosed methods.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore are not to be construed as limiting in any way the remainder of the disclosure.

### Example 1: Urban Work Zone Detection and Sizing: A Data-Centric Training and Topology-Based Inference Approach

This example addresses the challenges of automatically recognizing and sizing work zones in complex urban environments. A deep-learning based work zone object detection model was developed with a data-centric approach to iteratively enhance the model's performance by augmenting a custom training dataset collected from multiple sources, thereby overcoming the sparsity of annotated real-world work zone images. The training data was acquired from traffic cameras, mined from the web, and 3D-simulated work zone images. An innovative topology-based inference method is introduced, using XGBoost, for distinguishing true work zones from non-work operational zones with some work zone features. A reference-free work area size estimation method was also developed, which utilizes the standard heights of common construction equipment to provide a generalized real-pixel distance approximation. The disclosed model's efficacy is demonstrated with an average Mean Average Precision (mAP) of 74.1% across all work zone classes, an accuracy of 98.4% for scene identification, and an accuracy of up to 89.52% for size estimation. Overall, the disclosed approach (i.e., system and method for work zone management) significantly advances the capabilities of automated urban work zone detection and sizing, offering a cost-effective method to fill in the gap for the acquisition of work zone data in real-time by leveraging existing camera infrastructure.

In this example, a deep learning based framework (e.g., a system and method for work zone management) to effectively recognize urban work zone scenes and their sizes is provided. The main contributions of this disclosure are summarized as follows:

The data-centric training approach disclosed herein is designed to iteratively improve the performance of work zone object detection by augmenting a customized training dataset fused from multiple data sources to overcome the sparsity of annotated real-world work zone images. These sources include 2,600 images with 15,000 work zone object labels from traffic cameras, web-mined images, and synthetic work zone images generated through a 3D simulator.

A topology-based inference method was implemented using XGBoost to automatically identify work zone scenes. This innovative approach was designed to deal with the complexities of work zone scene detection caused by the fact that recognizing individual or certain combination of work zone components alone (e.g., a traffic cone behind a car) may not necessarily represent a true work zone.

A reference-free work zone size estimation method was developed, which utilizes the standard heights of common work zone equipment, to provide a generalized real-pixel distance rate method.

The methods are discussed herein.

Given these research gaps, there is a need to construct a data-centric approach for automated urban work zone detection, which allows continuous improvement of training data in terms of work zone imagery, as well as an effective recognition method capable of identifying complex urban work zone scenes, rather than focusing solely on individual work zone components and/or construction equipment.

The emerging field of Data-Centric AI is anticipated to introduce techniques for dataset optimization, thus enabling detection algorithms to be effectively trained even with relatively small datasets [M. Motamedi, N. Sakharnykh, and T. Kaldewey, “A data-centric approach for training deep neural networks with less data,” arXiv preprint arXiv: 2110.03613, 2021]. In this example, a data-centric framework for urban work zone detection and sizing is disclosed which contains three modules: a data-centric training that systematically augments training datasets with the goal of enhancing the accuracy of the work zone detection model, a topology-based work zone scene inference that can identify work zones by understanding the positional relationships and connections among detected work zone objects (e.g., cones placed adjacent to a line of fences), and a reference-free estimation for work zone size. Each part of the proposed detection methodology is described herein. FIG. 2 shows the working flow of the proposed method.

Data-Centric Training for Work Zone Object Detection: the development of the model began with collecting a customized dataset of 2,600 work zone images with about 15,000 labels from diverse sources including CCTVs, web-mined images, and a 3D simulator, offering a wide array of work zone scenarios (FIG. 2). This model was designed to identify several key work zone objects, such as traffic cones, construction workers and vehicles. Web-mined and 3D synthetic images primarily serve to fill the gaps in certain subcategories of the training data, which may be sparse in the CCTV images, yet their detection accuracy is vital for the model. For instance, web-mining is a good supplemental source for augmenting training images for construction vehicles. The quality of the data was incrementally improved by correcting label errors and pruning noisy labels based on data quality objectives.

Topology-Based Work Zone Scene Inference: once work zone objects were identified, their topological arrangement was analyzed. A topology complexity score was calculated based on the positional relationships and connections among these objects. The score serves as an indicator of whether the scene represents an organized work zone or a random accumulation of work zone objects for non-work zone purpose. The score was then fed into a XGBoost classifier, which is trained on ground truth work zone scene data.

Reference-Free Work Zone Size Estimation: after the presence of a work zone is confirmed, an estimation algorithm was performed to approximate the size of the work zone. This was accomplished using a reference-free method, which utilized the standard heights of common work zone equipment to establish a scale. With this scale, the distances and sizes of the objects in the work zone scene were calculated, allowing for the estimation of the work zone's size.

Data-Centric Training Pipeline: the key of work zone detection and sizing lies in accurately recognizing work zone-related objects. For the purposes of this study, seven key objects were focused on, including traffic cones, barricades, barrels, chain fences, construction vehicles, signs, and workers. The YOLOv8 model that integrates cutting-edge backbone and neck architectures with the mosaic augmentation method is used as it enhances both feature extraction and object detection, compared to previous YOLO versions [G. Jocher, A. Chaurasia, and J. Qiu, “Yolo by ultralytics,” 2023. [Online]. Available: https://github.com/ultralytics/ultralytics]. Given the absence of a pre-trained YOLOv8 model tailored to the required needs due to the lack of publicly available labeled roadway work zone data, a training set featuring work zone objects from the sources described in FIG. 2 was curated and manually labeled.

Data-centric model training recognizes that quality data is key to achieving better model performance, especially when dealing with real-world scenarios that are diverse and often unpredictable. Consider the objective of data-centric training in a simplified manner. Assume a model, defined by its parameters θ, and a dataset D=(xᵢ, yᵢ), where xᵢ is an instance (e.g., an image) and yᵢ is the corresponding label. In the typical model-centric training, optimal parameters θ* are sought that minimize a loss function L, averaged over all instances in the dataset:

$${θ}^{*} = arg {min}_{θ} \frac{1}{N} \sum L ( {y}_{i} , f ( {x}_{i} ; θ ) ) , for all i in D \qquad Equation l$$

Where f (xᵢ; θ) is the output of the model given instance xᵢ and model parameters θ.

In contrast, for the data-centric training, it was recognized that the dataset D itself might be sub-optimal, due to label errors or lack of image diversity. The notion of “dataset quality” q(D) was hence introduced, which outlines how good the data is. The goal then became to optimize not just the model parameters θ but also the dataset D itself:

$$( {θ}^{*} , {D}^{*} ) = arg {min}_{θ , D} \frac{1}{N} \sum L ( {y}_{i} , f ( {x}_{i} ; θ ) ) - λ * q ( D ) , for all i in D \qquad Equation 2$$

Here, λ is a regularization parameter balancing model loss and data quality. Enhancing dataset D might include correcting labeling errors, ensuring data representation, and introducing edge cases for model generalization.

In the disclosed example, the dataset was refined based on model performance, adding data and correcting/pruning label errors specifically for subclasses falling short of desired accuracy. The data-centric training pipeline is illustrated in FIG. 3.

Topology-based Work Zone Inference using XGBoost: an innovative topology-based work zone inference using XGBoost was introduced to reliably identify work zone scenes under real-world conditions. Instead of relying solely on the presence of work zone objects, this methodology considers their arrangement and inter-connectedness within the work zone. A topology complexity score is derived from these detected objects, illustrating their layout complexity. Work zone objects are clustered using a density-based clustering algorithm, DBSCAN [M. Ester, H.-P. Kriegel, J. Sander, X. Xu et al., “A density-based algorithm for discovering clusters in large spatial databases with noise.” in kdd, vol. 96, no. 34, 1996, pp. 226-231]. Any cluster with fewer than three items is considered as noise (i.e., non-work zone).

The topology complexity score views the detected work zone as a graph. From any random vertex, the algorithm searches for the nearest vertex with a degree less than two, then adds an edge between them. This process is repeated until every vertex in the graph is connected, and no vertex has a degree greater than two. The complexity is measured by the features of the generated graph, including the number of edge cross points, the ratio of cycles to chordless cycles, and the length distribution of edges. These measurements then serve as input variables in XGBoost, a gradient-boosting algorithm known for its efficiency and performance. XGBoost is used as the classifier to identify whether a certain scene represents a work zone or not. The classifier training uses manually annotated ground truth data from traffic cameras. The detailed algorithm including the steps for calculating a topology complexity score is provided in Algorithm 1 herein.

Algorithm 1: Topology Complexity Score

Require:

| | |
|---|---|
| 1: | Initialize a list of qualified clusters C_{q} from the results of DBSCAN consists |
| | with C. |
| 2: | Initialize an empty Graph G(V,E). |
| 3: | Initialize a list of available vertices Vₐ consists with all vertices vₐ in G having |
| | a degree less than or equal to 1. |
| 4: | N is the total number of vertices in C, n is the total number of vertices in G. |
| 5: | Original Vertex: v₀; Destination Vertex: v_{d}; Number of cycles: N_{c}; Number of |
| | chordless cycles: N_{ch}; Number of crossing edges: N_{cc} |
| 6: | |
| 7: | for each cluster C in C_{q} do |
| 8: | for each vertex v in C do |
| 9: | while n < N do |
| 10: | if G = Ø then |
| 11: | v₀ ← v |
| 12: | else if Degree of v_{d i} 2 then |
| 13: | v₀ ← v_{d} |
| 14: | else |
| 15: | v₀ ← ∀v ∈ Vₐ |
| 16: | end if |
| 17: | if Vₐ has more than two vertices then |
| 18: | Find the nearest vₐ and set it as v_{d} |
| 19: | Add an edge between v₀ and v_{d} |
| 20: | Update G and Vₐ |
| 21: | else if Vₐ has only two vertices then |
| 22: | Set the last vₐ other than v₀ as v_{d} |
| 23: | Add an edge between v₀ and v_{d} |
| 24: | Update G and Vₐ |
| 25: | end if |
| 26: | end while |
| 27: | Calculate N_{c}, N_{ch}, N_{cc} and the length of edges in G, store these |
| | attributes. |
| 28: | end for |
| 29: | Find graph G_{f} ← argmin_{N}_{_{c}}(G) |
| 30: | Obtain topology scores from G_{f} |
| 31: | end for |

Reference-free Work Zone Size Estimation: to overcome variance in camera positioning and perspective, a reference-free methodology for work zone size estimation was formed, based on standard heights of common work zone equipment such as traffic cones. This method, initially disclosed in previous work [F. Zuo, J. Gao, A. Kurkcu, H. Yang, K. Ozbay, and Q. Ma, “Reference-free video-to-real distance approximation-based urban social distancing analytics amid covid-19 pandemic,” Journal of Transport and Health, vol. 21, p. 101032, 2021] for pedestrian detection, eliminate the need for a physical scale reference in the scene which usually requires on-site human investigators.

The reference-free method divides the image into several hyper-planes, oriented perpendicularly to the horizontal plane and vanishing lines. Due to perspective effects, each hyper-plane exhibits a unique real-to-pixel distance ratio (RP-rate) as the number of pixels corresponding to a given real-world length varies between hyper-planes. Next, it was proposed that each specific type of work zone equipment in the image stands perpendicular to the horizontal plane and maintains a uniform actual height hᵣ. FIG. 4 provides an example illustrating the proposed area estimation method. Subsequently, the detected object (vertex) is ranked according to the RP rate, and one edge is then added to the adjunct vertices. Combining the final graph G_{f} generated from Algorithm 1 and removing the duplicated edges, a set of sub-cycles are generated. The calculation of the real distance is considered as the integration of the product between RP-rate and pixel distance Δp [F. Zuo et al., “Reference-free video-to-real distance approximation-based urban social distancing analytics amid covid-19 pandemic,” Journal of Transport and Health, vol. 21, p. 101032, 2021]. Similarly, the real area size of each chordless cycle can be formulated as the integration of the product between RP rate and the pixel area size Δs. Given that each cycle comprises at least three vertices, it's straightforward to divide a cycle into sub-cycles between two neighboring vertices using a supplementary vertical line.

A horizontal line is added from each vertex inside the generated work zone area, and then the area is separated into sub-region (SC1 to SC3 in FIG. 4). Each sub-region is considered as many small rectangles, and the length of the rectangle is the real distance between the region's bounds, l, which can be calculated using the pixel distance multiplied by the RP rate. The rectangle width is calculated using the method introduced in [F. Zuo et al., “Reference-free video-to-real distance approximation-based urban social distancing analytics amid covid-19 pandemic,” Journal of Transport and Health, vol. 21, p. 101032, 2021] due to the perspective effect. Thus, each sub-region can be calculated as a double integral that is written as:

$${A}_{SC} = {\int }_{a}^{b} {\int }_{{r}_{a}}^{{r}_{b}} {l}_{r} d l d r \qquad Equation 3$$

where the a and b are the two vertices, lₐ and l_{b} are the horizontal distance between the work zone bounds at vertex a and b; rₐ and r_{b} are the RP rates of vertex a and b, which can be calculated as follow:

$${r}_{R P}^{i} = \frac{{h}_{r}}{{h}_{p}^{i}} \qquad Equation 4$$

where hₚⁱ is the pixel height of the detected equipment, and hᵣ is the real height of the equipment type. In the disclosed study, the height of a barrel, a cone and a barricade is assumed to be 37, 28, and 42 inches, respectively.

The results are discussed herein.

To prove the effectiveness of the disclosed framework in urban work zone detection, the detection model performance was evaluated using precision-recall (PR) curve and mAP over Intersection over Union (IoU) 0.5 (mAP@0.5) based on different training datasets. Then, the performance of the work zone scene identification and size estimation was assessed based on confusion matrix, accuracy and F1 score.

Work zone object detection model performance: the training data was primarily derived from a subset of the 900+ fixed CCTV traffic cameras in New York City (nyctmc.org), providing a variety of urban work zone images under different lighting, weather, and traffic conditions, although with relatively low resolution (i.e., 240p). Free stock images sourced from the web and synthetic images from a 3D simulator were also incorporated as supplement data sources in addition to the CCTV images. The free stock images provided high-resolution depictions of specific classes, such as construction workers or vehicles, while the 3D simulator generated synthetic work zone images from various angles and work zone setups under controlled conditions. The disclosed approach bridges gaps in areas where real-world data may be scarce. For instance, if there are few examples of night-time work zones in the actual data, these scenarios can be simulated in 3D. This ensures the data-centric training dataset comprehensively covers all possible scenarios-a crucial aspect for training a robust model.

Among the 2,600 images collected and annotated, 890 CCTV, 850 stock, and 280 synthetic 3D images were used as the training data, and 580 CCTV images were used as the test/validation data. The YOLOv8 was used as the model, trained on four customized training models for 300 epochs, and evaluated on the test set. The four training models were: 1) baseline model uses original CCTV data without data-centric processing, 2) DC-CCTV uses CCTV data with data-centric processing, 3) DC-CCTV+Stock uses CCTV and free stock data with data-centric processing, and 4) DC-CCTV+Stock+3D uses CCTV, free stock and synthetic 3D data with data-centric processing.

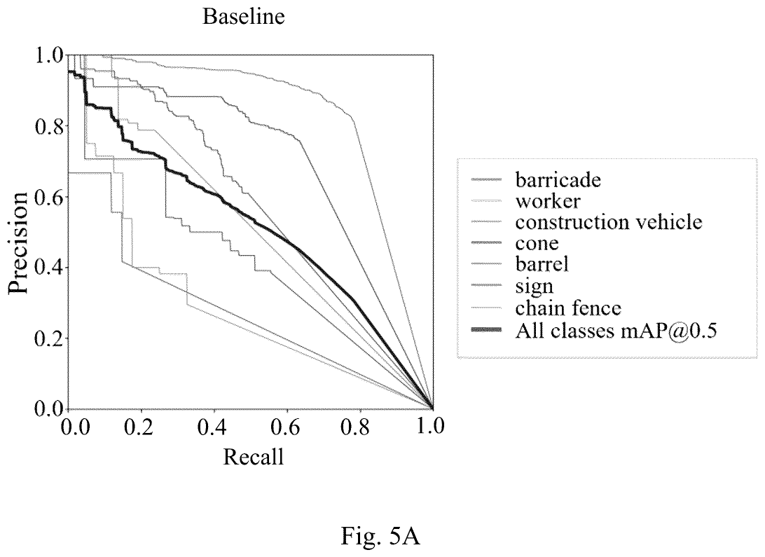

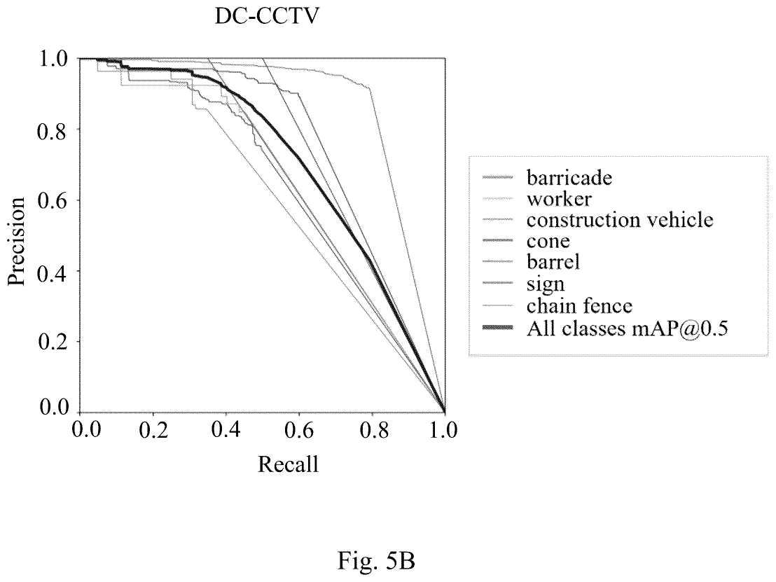

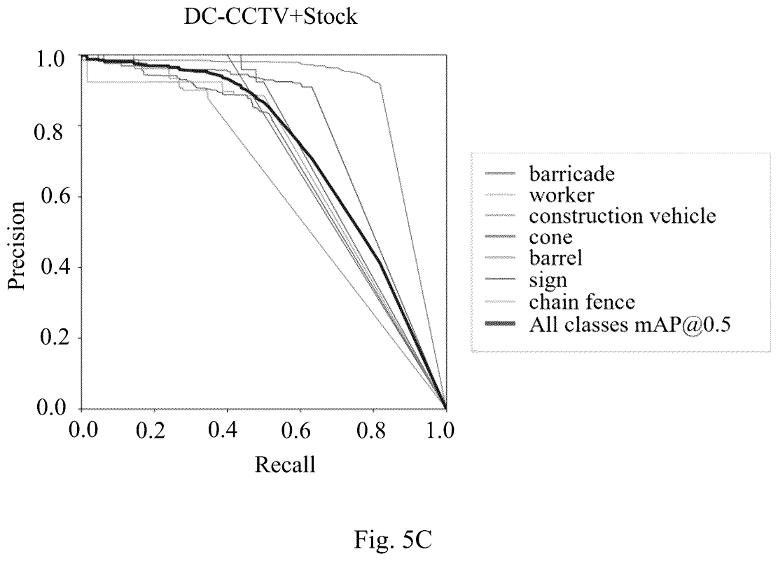

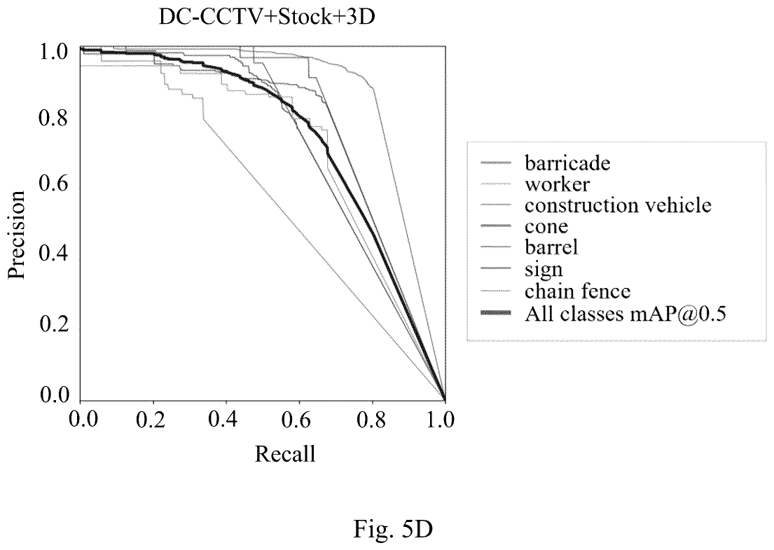

FIGS. 5A through 5D are plots displaying precision-recall (PR) curves of model validation from baseline model, and data-centric (DC) trained models using different training data sources combinations. The performance, compared to the baseline, saw substantial improvement after implementing data-centric training in DC-CCTV, which included data cleaning and re-labeling. Furthermore, when additional data sources were added to the training data pool, overall model performance increased due to data enhancement processing (FIGS. 5C and 5D), especially for subclass barricade, construction vehicle, work zone sign, and chain fence. Table 1 presents the mAP@0.5 scores for each work zone object class. Interestingly, a marginal decline is observed in performance for certain specific types upon data augmentation. A possible explanation is that the inclusion of stock and synthetic 3D images broadened the model's generalization thus reduced the risk of overfitting.

TABLE 1
TRAINING PERFORMANCE COMPARISON

| Detection | Base | Data-Centric Training | | |
|---|---|---|---|---|
| Type | CCTV | CCTV | CCTV + Stock | CCTV + Stock + 3D |
| barricade | 0.572 | 0.644 | 0.680 | 0.725 |
| worker | 0.516 | 0.610 | 0.620 | 0.579 |
| const. veh | 0.272 | 0.675 | 0.700 | 0.737 |
| cone | 0.692 | 0.755 | 0.773 | 0.764 |
| barrel | 0.830 | 0.871 | 0.882 | 0.872 |
| sign | 0.424 | 0.750 | 0.727 | 0.799 |
| chain fence | 0.291 | 0.655 | 0.680 | 0.713 |
| ALL | 0.514 | 0.708 | 0.723 | 0.741 |

(All values are mAP@0.5)

Work zone scene identification model performance: for XGBoost training, 684 CCTV images were selected, 399 containing unique work zones and 285 containing work zone objects that do not constitute work zones (e.g., cones for lane control). Features like work zone shape, equipment count, number of crossing edges, the ratio of the cycle over the chordless cycle, and the number of edge outliers were manually labeled for model training. The trained model was tested on 853 CCTV images, with the confusion matrix presented in Table 2.

TABLE 2
WORK ZONE DETECTION CONFUSION METRICS

| | True WZ | True Non-WZ |
|---|---|---|
| Predicted WZ | 15 | 5 |
| Predicted Non-WZ | 17 | 826 |

(WZ: Work Zone)

Upon analyzing the confusion matrix, it is noted that the accuracy of the model is 98.4%, whereas the F1 score stands at 0.713. The discrepancy between these metrics can largely be attributed to the skewed distribution of the dataset, where the majority of data points are not associated with a work zone. Despite the inherent bias indicated in the F1 score, the results showcase practical applicability and offer satisfactory performance in real-world contexts.

Work zone size estimation model performance: FIGS. 6A through 6D presents examples of work zone inference and area estimation show in exemplary screens of a GUI. FIGS. 6A through 6D show the output of work zone detection, inference, and area estimation. FIGS. 6A & 6B highlight detected work zones in orange, with estimated sizes at the bottom right. FIGS. 6C & 6D show correct detection of non-work zones that contain work zone equipment. The first two images (FIGS. 6A & 6B) accurately identify work zones and their sizes, while the last two images (FIGS. 6C & 6D) avoid false positives despite the presence of work zone equipment. This demonstrates the disclosed model's accuracy even in complex environments. The disclosed method was evaluated using ten real-world images, manually estimating work zone sizes via satellite images. The method achieved an accuracy within a range of 67.71% to 89.52%.

It should be noted that the area estimation methodology functions most optimally when the identified boundary equipment forms a closed enclosure.

In this example, a multi-facet framework combines data-centric AI training, topological analysis, gradient boosting classification, and reference-free size estimation, forming a comprehensive work zone detection toolkit. An iterative training data improvement process was shown by supplementing additional data, and performing label correction/pruning techniques for low-accuracy classes. An innovative topology-based inference and size estimation method was introduced to enable work zone scene identification using the positional relationships and connections among work zone objects. Several experiments for each module were conducted to prove their individual accuracy and robustness.

In summary, this holistic approach enables real-time identification and size estimation of work zones with reasonable accuracy under complex urban settings. This can potentially facilitate the provision of more informed active work zone management, thereby improving safety and mobility in the presence of work zones. As the proposed approach was empirically validated using existing traffic camera infrastructure in NYC, it also shows its potential as a new mechanism for generating real-time work zone data remotely in a cost-effective manner. In some embodiments, any systems or methods of the present disclosure may be combined and/or used with traffic and incident detection, as well as work zone permit database, to facilitate a more effective TMS in the future.

### Example 2: A-Eye Urban

Empowering cities with visual data, the disclosed system and method, in some examples referred to as “A-Eye Urban platform” transforms traffic cameras into ‘smart sensors’ for real-time work zone management and safety assessments. Two applications, WorkZoneX and SAFExMAP, were developed and embedded in the platform. WorkZoneX is a system and method for detecting urban work zone sites, active work zones with workers, traffic condition around the work zones, and estimating work zone size in real time using two-dimensional visual data obtained from publicly available traffic cameras. The current version of WorkZoneX is capable of detecting 11 work zone related equipment or objects, including traffic cones, barrels, delineators, construction workers, construction vehicles, work zone signs, fence, barricade, vent, manhole guardrail and trench cover. SAFExMAP provides a traffic safety risk indicator scoring system with a map interface that leverages near-miss data gathered from in-vehicle cameras via computer vision as well as other publicly available data including crash records, speeding tickets, and street characteristics. This application contains a method developed by the team to calculate a scaled safety risk index.

A-Eye Urban platform is a system that employs a microservices architecture, separating various functions to simplify development, testing, and maintenance. The microservice architecture comprises several distinct components: a collector for retrieving real-time videos or images from camera sources, a detector applying computer vision algorithms, a log collector, and a statistical analyzer to evaluate detection results. Additionally, a work zone service, a safety risk service, a front-end, and an API gateway, which offers web services, are provided.

WorkZoneX: urban workzone detection in a city, region or area, providing a web-based tool using computer vision and publicly available traffic cameras. Computer vision in transportation has primarily focused on detecting pedestrians and vehicles, with limited use for other scenarios like work zone detection, especially in the complex urban environment. Current studies mainly target off-street work zones, highway work zones or single object types, and lack publicly available annotated work zone images. Most rely on specific cameras, with few utilizing existing infrastructures like CCTV. Advantages of the developed system, WorkZoneX, include:

The system uses a data-centric training approach designed to iteratively improve the performance of work zone object detection by augmenting a customized training dataset fused from multiple data sources to overcome the sparsity of annotated real-world work zone images. These sources include 2,600 images with 15,000 work zone object labels from publicly available traffic cameras, web-mined images, and synthetic work zone images generated through a 3D simulator.

The system uses a topology-based inference method using XGBoost to automatically identify work zone scenes. This innovative approach is designed to deal with the complexities of work zone scene detection caused by the fact that recognizing individual or certain combination of work zone components alone (e.g., a traffic cone behind a car) may not necessarily represent a true work zone. To the best of our knowledge, there is no such product exists that deals with this issue.

The system also uses a reference-free work zone size estimation method, which utilizes the standard heights of common work zone equipment, to provide a generalized real-pixel distance rate method.

This system represents the first real-time, web-based tool for work zone detection focusing on complex urban environments. All off-the-shelf work zone detection tools primarily focus on highway work zone detection or detecting only a few types of work zone equipment, like traffic cones. WorkZoneX is capable of detecting 11 different work zone related equipment of objects.

SAFExMAP: Historical crash data is crucial for traffic safety analysis and interventions. However, issues such as rarity of crashes, underreporting, and low location accuracy hinder its use. With the advent of computer vision technology, tools like in-vehicle cameras can detect near misses in real-time. This provides a broader understanding of potential hazards and unreported close calls. Analyzing near miss incidents can significantly enhance road safety, preventing serious or costly accidents. However, it is still unclear to most transportation agencies in how to use and visualize near misses data in a meaningful way, in addition to crash records. The novel features of SAFExMAP includes: 1) Developed a method to study the correlation between crash records and near-miss data at global and local levels using computer vision. 2) Created a novel data fusion based Scaled Safety Risk Index (SSRI) using statistical and machine learning techniques. This index incorporates multi-source crash frequency-related variables weighted by their importance, offering a new and comprehensive measure of traffic safety risk. 3) Embedded SSRI into SAFExMAP, a web tool, enabling stakeholders to identify high-risk areas and understand traffic safety factors. The SAFExMAP provides data visualization and spatiotemporal analysis of various safety-related data in a city, region, or area. This includes crash records, near-misses, and other road hazards detected by computer vision techniques via in-vehicle cameras (e.g., provided by an industry partner), as well as speeding tickets. The SSRI is calculated using a method that combines sociodemographic data, crash records, and near-misses identified by computer vision. A higher rank (e.g., Rank 1) indicates a higher safety risk in the region.

FIGS. 9A through 12 are images depicting a user interface (UI) for an exemplary work zone management system comprising work zone detection and sizing according to aspects of the present invention. FIG. 9A-9E depicts an exemplary dashboard for the UI. FIGS. 10A & 10B show a map view for the UI with selected work zone images displayed adjacent to the map view. FIGS. 11A & 11B show a map view for the UI with various metrics (e.g., safety, speed of vehicles, etc.). FIG. 12 depicts an exemplary traffic detection module or toolbox for the UI allowing a user to upload an image for work zone identification, detection and/or size estimation according to aspects of the present invention.

The disclosures of each and every patent, patent application, and publication cited herein are hereby each incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A method for work zone management, comprising the steps of:
providing one or more images of a work zone;
analyzing the one or more images to detect one or more work-zone related objects within the work zone;
sizing the detected work-zone related objects by comparing the detected objects to known sizes of common work zone equipment to establish a scale;
calculating estimated positions of the one or more work-zone related objects;
mapping the one or more work-zone related objects to a topological map;
calculating a topology complexity score based on the topological map; and
determining whether the work zone is an organized work zone or a random accumulation of work zone objects, based on the topology complexity score.

2. The method of claim 1, wherein the step of mapping the one or more work-zone related objects to a topological map comprises detecting and recording the inter-connectedness of the one or more work-zone related objects within the work zone.

3. The method of claim 1, wherein the step of calculating a topology complexity score comprises utilizing density-based clustering algorithms to group the detected work zone related objects and calculating the score based on the resulting graph features.

4. The method of claim 1, wherein the one or more work-zone related objects are selected from traffic cones, barricades, barrels, chain fences, construction vehicles, signs, or workers.

5. The method of claim 1, further comprising the step of obtaining images of the work zone from traffic cameras, web-mined images, or synthetic work zone images generated by a 3D simulator.

6. The method of claim 1, further comprising the step of estimating the work zone size using the established scale.

7. The method of claim 6, wherein the step of estimating the work zone size further comprises dividing the image of the identified work zone into hyper-planes oriented perpendicularly to the horizontal plane, calculating the real-to-pixel distance ratios for each hyper-plane, and estimating the work zone size based on known sizes of common work zone equipment.

8. The method of claim 1, further comprising the step of training a machine learning model by iteratively augmenting a training dataset with additional images of work zones.

9. A system for work zone management, comprising:
a non-transitory computer-readable medium with instructions stored thereon, which when executed by a processor, performs the steps of claim 1.

10. A method for work zone size estimation, comprising:
providing a weighted graph of roads in a locality comprising a plurality of nodes and a plurality of edges connecting the nodes, each node representing an intersection and each edge representing a road;
providing one or more images of a work zone in the locality;
analyzing the one or more images to detect one or more work-zone related objects within the work zone;
calculating estimated positions of the one or more work-zone related objects using known approximate sizes of the work-zone related objects;
mapping the one or more work-zone related objects to a topological map;
calculating an estimated work zone size based on the topological map;
calculating a topology complexity score based on the topological map;
adjusting a weight of at least one edge in the weighted graph based on the calculated size and topology complexity score; and
providing the updated weighted graph to a database in real time.

11. The method of claim 10, wherein the step of mapping the one or more work-zone related objects to a topological map comprises detecting and recording the inter-connectedness of the one or more work-zone related objects within the work zone.

12. The method of claim 10, wherein the step of calculating a topology complexity score comprises utilizing density-based clustering algorithms to group the detected work zone related objects and calculating the score based on the resulting graph features.

13. The method of claim 10, wherein the one or more work-zone related objects are selected from traffic cones, barricades, barrels, chain fences, construction vehicles, signs, or workers.

14. The method of claim 10, further comprising the step of obtaining images of the work zone from traffic cameras, web-mined images, or synthetic work zone images generated by a 3D simulator.

15. The method of claim 10, further comprising the step of estimating the work zone size using the established scale.

16. The method of claim 10, wherein the step of estimating the work zone size further comprises dividing the image of the identified work zone into hyper-planes oriented perpendicularly to the horizontal plane, calculating the real-to-pixel distance ratios for each hyper-plane, and estimating the work zone size based on known sizes of common work zone equipment.

17. The method of claim 10, further comprising the step of training a machine learning model by iteratively augmenting a training dataset with additional images of work zones.

18. A system for work zone size estimation, comprising:
a non-transitory computer-readable medium with instructions stored thereon, which when executed by a processor, performs the steps of claim 10.
